(19) United States
(12) Patent Application Publication
(10) Pub. No.: US 2023/0055605 A1
(43) Pub. Date: Feb. 23, 2023

(54) TARGETED, CRITERIA-SPECIFIC PROVISIONING OF DIGITAL CONTENT BASED ON STRUCTURED MESSAGING DATA

(71) Applicant: The Toronto-Dominion Bank, Toronto (CA)

(72) Inventors: Christopher Mark JONES, Villanova, PA (US); Barry Wayne BAIRD, JR., Kennett Square, PA (US); Claude Bernell LAWRENCE, JR., Philadelphia, PA (US); Jonathan Joseph Prendergast, West Chester, PA (US)

(21) Appl. No.: 17/889,221

(22) Filed: Aug. 16, 2022

Related U.S. Application Data
(60) Provisional application No. 63/234,118, filed on Aug. 17, 2021.

(51) Int. Cl. G06Q 20/20; G06Q 20/40

(52) U.S. Cl. CPC G06Q 20/203; G06Q 20/401

(57) ABSTRACT

The disclosed embodiments include computer-implemented systems and processes that generate and provision targeted, criteria-specific digital content based on structured messaging data. For example, an apparatus may receive a message associated with a real-time payment requested from a first counterparty by a second counterparty, and the message includes elements of message data characterizing an exchange of data initiated between the first and second counterparties. The apparatus may determine a value of a first parameter of the initiated data exchange based on the elements of message data, and based on a determined inconsistency between the first parameter value and an execution criterion, the apparatus may transmit a notification that includes product data characterizing an available product to a device operable by the first counterparty for presentation within a digital interface.

### CROSS-REFERENCE TO RELATED APPLICATION

This application claims the benefit of priority to U.S. Provisional Patent Application No. 63/234,118, filed on Aug. 17, 2021, the entire disclosure of which is expressly incorporated herein by reference to its entirety.

### TECHNICAL FIELD

The disclosed embodiments generally relate to computer-implemented systems and processes that provision targeted, criteria-specific digital content based on structured messaging data.

### BACKGROUND

The mass adoption of smart phones and digital payments within the global marketplace drives an increasingly rapid adoption of real-time payment (RTP) technologies by financial institutions, consumers, vendors and merchants, and other participants in the payment ecosystem. RTP technologies often emphasize data, messaging, and global interoperability and in contrast to many payment rails, such as those that support credit card payments, embrace the near ubiquity of mobile technologies in daily life to provide, to the participants in the RTP ecosystem, real-time service and access to funds.

### SUMMARY

In some examples, an apparatus includes a communications interface, a memory storing instructions, and at least one processor coupled to the communications interface and to the memory. The at least one processor is configured to execute the instructions to receive, via the communications interface, a message associated with a first real-time payment requested from a first counterparty by a second counterparty. The message includes elements of message data disposed within corresponding message fields, and the message data characterizes an exchange of data initiated between the first and second counterparties. The at least one processor is further configured to execute the instructions to determine a value of a first parameter of the initiated data exchange based on the elements of message data, and to determine that the first parameter value is inconsistent with an execution criterion. The at least one processor is further configured to execute the instructions to, based on the determined inconsistency, generate product data characterizing a product available to the first counterparty, and to transmit, via the communications interface, notification data to a first device operable by the first counterparty. The notification data includes digital content associated with the available product and with the data exchange, and the first device is configured to present at least a portion of the digital content within a digital interface.

In other examples, a computer-implemented method includes receiving, using at least one processor, a message associated with a first real-time payment requested from a first counterparty by a second counterparty. The message includes elements of message data disposed within corresponding message fields, and the message data characterizes an exchange of data initiated between the first and second counterparties. The computer-implemented method also includes, using the at least one processor, determining a value of a first parameter of the initiated data exchange based on the elements of message data, and determining that the first parameter value is inconsistent with an execution criterion. The computer-implemented method also includes, based on the determined inconsistency, generating, using the at least one processor, product data characterizing a product available to the first counterparty, and transmitting, using the at least one processor, notification data to a first device operable by the first counterparty. The notification data includes digital content associated with the available product and with the data exchange, and the first device is configured to present at least a portion of the digital content within a digital interface.

Further, in some examples, a tangible, non-transitory computer-readable medium storing instructions that, when executed by at least one processor, cause the at least one processor to perform a method that includes receiving a message associated with a first real-time payment requested from a first counterparty by a second counterparty. The message includes elements of message data disposed within corresponding message fields, and the message data characterizes an exchange of data initiated between the first and second counterparties. The method also includes determining a value of a first parameter of the initiated data exchange based on the elements of message data, and determining that the first parameter value is inconsistent with an execution criterion. The method also includes, based on the determined inconsistency, generating product data characterizing a product available to the first counterparty, and transmitting notification data to a first device operable by the first counterparty. The notification data includes digital content associated with the available product and with the data exchange, and the first device is configured to present at least a portion of the digital content within a digital interface.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary computing environment, in accordance with some exemplary embodiments.

FIG. 2A is a block diagram illustrating a portion of an exemplary computing environment, in accordance with some exemplary embodiments.

FIG. 2B illustrates portions of an exemplary request for payment (RFP) message, in accordance with some exemplary embodiments.

FIGS. 3A, 3B, 4A, 4B, and 4C are block diagrams illustrating portions of an exemplary computing environment, in accordance with some exemplary embodiments.

FIGS. 5A, 5B, and 5C are flowcharts of exemplary processes for provisioning, in real-time, targeted product data associated with initiated data exchanges to customer devices based on structured messaging data, in accordance with some exemplary embodiments.

Like reference numbers and designations in the various drawings indicate like elements.

### DETAILED DESCRIPTION

Today, the mass adoption of smart phones and digital payments within the global marketplace drives an adoption of real-time payment (RTP) technologies by financial institutions, consumers, vendors and merchants, and other participants in the payment ecosystem. These RTP technologies often emphasize data, messaging, and global interoperability and in contrast to conventional payment rails, may embrace the near ubiquity of mobile technologies in daily life to provide, to the participants in the RTP ecosystem, real-time service and access to funds. To facilitate the strong emphasis on data, messaging, and global interoperability between financial institutions, many RTP technologies adopt, and exchange data formatted in accordance with, one or more standardized data-exchange protocols, such as the ISO 20022 standard for electronic data exchange between financial institutions.

For example, a customer of a financial institution may initiate a plurality of transactions to purchase one or more products or services from corresponding merchants or retailers, either through in-person interaction at a physical location of the merchant or retailer, or through digital interactions with a computing system of the merchant (e.g., via a web page or other digital portal). In some instances, and to fund the initiated purchase transaction, the customer may provide each of the merchants with data characterizing a payment instrument, such as credit card account issued by the financial institution (e.g., via input provisioned to the web page or digital portal, or based on an interrogation of a physical payment card by point-of-sale terminal, etc.). The merchant computing system may generate elements of messaging data that identify and characterize the corresponding merchant and the corresponding initiated purchase transaction, and that include portions of the data characterizing the payment instrument, and the merchant computing system may submit the generated elements of messaging data to a transaction processing network or payment rail in accordance with a predetermined schedule (e.g., in batch form with other elements of messaging data at a predetermined time on a daily basis). In some instances, one or more computing systems of the transaction processing network or payment rail may perform operations that execute, clear, and settle each of the initiated purchase transactions involving the corresponding payment instrument within a predetermined temporal interval subsequent to the initiation of the purchase transaction, such as, but not limited to, forty-eight hours.

In other examples, the merchant (or the financial institution of the merchant) and the financial institution of the customer may represent participants in the RTP ecosystem, and the merchant computing system (or a computing system associated with the financial institution of the merchant) may generate a corresponding message (e.g., a Request for Payment (RFP) message) requesting a real-time payment from the customer that funds the corresponding initiated purchase transaction, and may transmit the RFP message to one or more computing systems of the financial institution of the customer (e.g., directly or through one or more intermediate systems associated with the RTP ecosystem, such as a clearinghouse system). The generated and transmitted RFP message may, for example, be formatted in accordance with the ISO 20022 data-exchange format, and may include message fields populated with data

The data populating the message fields of the ISO-20022-compliant RFP message may include, is not limited to, information identifying the customer and the corresponding merchant, information characterizing the corresponding requested payment (e.g., a requested payment amount, a requested payment date, an identifier of an account selected by the customer to fund the requested, real-time payment, or an identifier of an account of the merchant capable of receiving proceeds from requested, real-time payment, etc.), and information characterizing the initiated purchase transaction (e.g., a transaction date or time, or an identifier of one or more of the products or services involved in the initiated purchase transaction, such as a corresponding UPC, etc.). Further, the ISO-20022-compliant RFP message may also include a link within a structured or unstructured message field to information, such as remittance data, associated with the requested, real-time payment (e.g., a long- or shortened Uniform Resource Location (URL) pointing to formatted invoice data in that includes any of the information described herein).

When intercepted and decomposed by a computing system of the financial institution of the customer (e.g., an FI computing system), the elements of structured or unstructured data maintained within the message fields of the ISO-20022-compliant RFP message may be processed by the computing system of the financial institution to establish, in real-time, a consistency, or inconsistency, between an execution of the requested, real-time payment with one or more execution criteria associated with the customer, a corresponding merchant, the requested payment, or the transaction. Based on an established inconsistency of requested, real-time payment with one or more of the execution criteria, the FI computing system may decline to execute and fund the requested, real-time payment using the account selected by the customer, and in some instances, the FI computing system may perform operations that broadcast an additional ISO-20022-compliant message, such as an ISO-20022-compliant error message, characterizing the decision to decline the execution of the requested real-time payment across a communications network to the computing system of the merchant, either directly or through one or more intermediate computing systems associated with the RTP ecosystem.

In other instances, based on the elements of structured or unstructured data maintained within the message fields of the ISO-20022-compliant RFP message, which extend beyond the often-limited content of the message data transmitted across many existing payment rails and transaction processing networks, the FI computing system may perform operations to determine adaptively the terms and conditions of a financial product that is “pre-approved” for provisioning to the customer by the financial institution, and that is appropriate to fund the declined real-time payment, in accordance with determined terms and conditions. By way of example, and using any of the exemplary processes described herein, the computing system of the financial institution may provision, to a device operable by the customer, a product notification that identifies and characterizes the pre-approved financial product, such as a loan product, and the terms and conditions associated with that available financial product, and an application program executed by the customer device may perform operations, described herein, that render the product notification for presentation with a portion of a digital interface.

Upon presentation within the digital interface of the customer device, the product notification may, among other things, identify the pre-approved financial product and the determined terms and conditions, and may prompt the customer to accept, or alternatively decline, the offer to fund the requested, real-time payments associated with the initiated purchase transaction (e.g., associated with the ISO-20022-compliant RFP message) using the available financial product in accordance with the determine terms and conditions. Further, and based on confirmation data indicative of the customer acceptance of the offered financial product, the computing system of the financial institution may perform any of the exemplary processes described herein to issue the now-accepted financial product to the customer, and to generate an additional, ISO-2002-compliant RTP message that, when provisioned to the computing system of the merchant associated with the initiated purchase transaction (or to an intermediate computing system, such as a computing system of the merchant's financial institutions), provides the corresponding requested payment using funds drawn from the issued financial product in real-time and contemporaneously with the initiation of the purchase transaction and the real-time payment requested by the merchant (and further, contemporaneously with the decision of the FI computing system to decline to execute the requested, real-time payment).

Certain of the exemplary processes, described herein, which decompose the structured message fields of an ISO-20022-compliant RFP message to obtain corresponding elements of decomposed message data characterizing a customer, a merchant, and an initiated purchase transaction, and a real-time payment requested from the customer by the merchant, which analyze the elements of decomposed message data to not only decline to execute and fund the requested, real-time payment using a customer-specific funding account, but also to determine terms and conditions of a loan product appropriate to, and available to, fund the declined, real-time payment requested by the merchant, and which provision data characterizing the available loan product to the customer device for presentation within a digital interface in real-time and contemporaneously with the initiated purchase transaction, may be implemented in addition to, or as an alternate to, many processes that rely on the often-limited content of temporally delayed message data transmitted across many existing payment rails and transaction processing networks.

### A. Exemplary Computing Environments

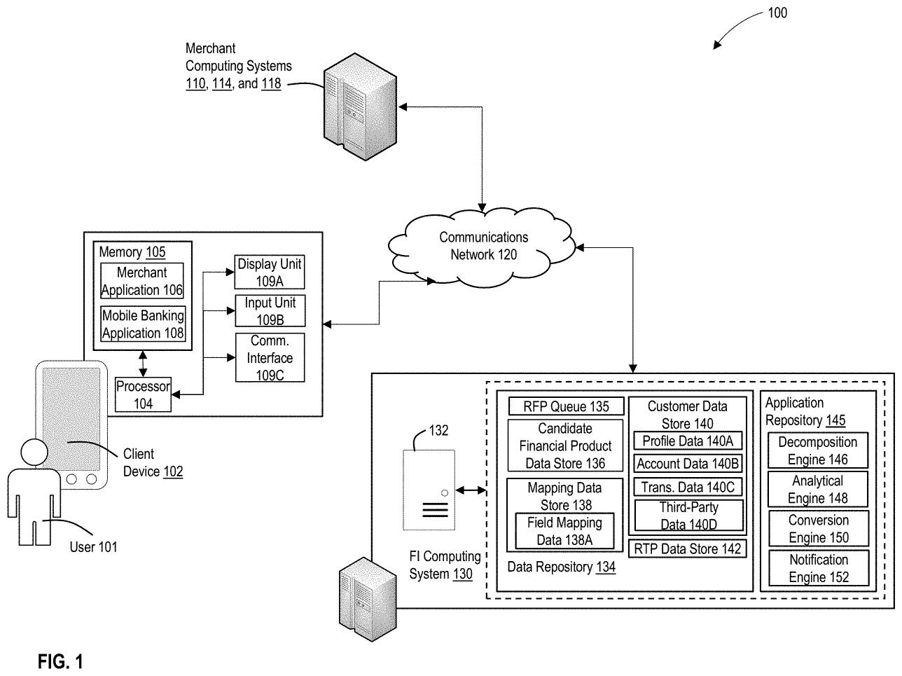

FIG. 1 is a diagram illustrating an exemplary computing environment 100 that includes, among other things, one or more computing devices, such as a client device 102, and one or more computing systems, such as one or more merchant computing systems (including merchant systems 110, 114, and 118), and a financial institution (FI) computing system 130, each of which may be operatively connected to, and interconnected across, one or more communications networks, such as communications network 120. Examples of communications network 120 include, but are not limited to, a wireless local area network (LAN) (e.g., a “Wi-Fi” network), a network utilizing radio-frequency (RF) communication protocols, a Near Field Communication (NFC) network, a wireless Metropolitan Area Network (MAN) connecting multiple wireless LANs, and a wide area network (WAN) (e.g., the Internet).

Client device 102 may include a computing device having one or more tangible, non-transitory memories, such as memory 105, that store data and/or software instructions, and one or more processors, e.g., processor 104, configured to execute the software instructions. The one or more tangible, non-transitory memories may, in some instances, store software applications, application modules, and other elements of code executable by the one or more processors, such as, but not limited to, an executable web browser (e.g., Google Chrome™, Apple Safari™, etc.), an executable application associated with one of merchant systems 110, 114, or 118 (e.g., merchant application 106), and additionally, or alternatively, an executable application associated with FI computing system 130 (e.g., mobile banking application 108).

Client device 102 may also include a display unit 109A configured to present interface elements to a corresponding user, such as a user 101, and an input unit 109B configured to receive input from user 101 (e.g., in response to the interface elements presented through display unit 109A). By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device (e.g., a pressure-sensitive touchscreen display unit that presents interface elements and receives input from user 101). Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client device 102 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. In some instances, client device 102 may also establish communications with one or more additional computing systems or devices operating within environment 100 across a wired or wireless communications channel (e.g., via the communications interface 109C using any appropriate communications protocol). Further, user 101 may operate client device 102 and may do so to cause client device 102 to perform one or more exemplary processes described herein.

Each of the one or more merchant computing systems, including merchant computing systems 110, 114, and 118, and FI computing system 130 may represent a computing system that includes one or more servers and one or more tangible, non-transitory memory devices storing executable code, application engines, or application modules. Each of the one or more servers may include one or more processors, which may be configured to execute portions of the stored code, application engines, or application modules to perform operations consistent with the disclosed exemplary embodiments. For example, as illustrated in FIG. 1, the one or more servers of FI computing system 130 may include server 132 having one or more processors configured to execute portions of the stored code, application engines, or application modules maintained within the one or more corresponding, tangible, non-transitory memories. In some instances, each of the merchant computing systems, including merchant computing systems 110, 114, and 118, and/or FI computing system 130 may correspond to a discrete computing system, although in other instances, one or more of merchant computing systems 110, 114, and 118, or FI computing system 130, may correspond to a distributed computing system having multiple, computing components distributed across an appropriate computing network, such as communications network 120 of FIG. 1, or those established and maintained by one or more cloud-based providers, such as Microsoft Azure™, Amazon Web Services™, or another third-party, cloud-services provider. Further, each of the merchant computing systems, including merchant computing systems 110, 114, and 118, and FI computing system 130 may also include one or more communications units, devices, or interfaces, such as one or more transceiver devices, coupled to the one or more processors for accommodating wired or wireless internet communication across network 120 with other computing systems and devices operating within environment 100 (not illustrated in FIG. 1).

By way of example, each of the merchant computing systems 110, 114, and 118 may be associated with, or operated by, a corresponding merchant that offers products or services for sale to one or more customers, such as, but not limited to, user 101 that operates client device 102. In some instances, described herein, merchant computing system 110 may be associated with, or operated by, a local home roofing contractor (e.g., “Sam's Roofing”), merchant system 114 may be associated with, or operated by, a local home-improvement contractor (e.g., “Lex's Home Improvement”), and merchant system 118 may be associated with, or operated by, a local landscaping company (e.g., “Leo's Lawn Care”). Further, one or more of the merchant computing systems 110, 114, and 118 may exchange data programmatically with one or more application programs executed at client device 102, such as merchant application 106, and based on the programmatically exchanged data, client device 102 may perform any of the exemplary processes described herein to initiate a transaction to purchase one or more of the products or services offered for sale by corresponding ones of the merchants.

As described herein, FI computing system 130 may be associated with, or operated by, a financial institution that offers financial products or services to one or more customers, such as, but not limited to, user 101. The financial products or services may, for example, include a financial product issued to user 101 by the financial institution and available to fund the initiated purchase transaction, and examples of the payment instrument may include, but are not limited to, a credit card account issued by the financial institution, a secured or unsecured credit product issued by the financial institution (e.g., an unsecured or secured line-of-credit, an unsecured personal loan, etc.), or a checking, savings, or other deposit account issued by and maintained at the financial institution.

In some instances, FI computing system 130 may perform any of the exemplary processes described herein to obtain, receive, or intercept a plurality of request-for-payment (RFP) messages associated with purchase transactions initiated by a first counterparty (e.g., user 101 of FIG. 1) and involving corresponding second counterparties (e.g., the local roofing contractor, the local home-improvement contractor, or the local landscaping company associated with corresponding ones of merchant computing systems 110, 114, or 118 of FIG. 1). As described herein, the received RFP messages may be formatted and structured in accordance with one or more standardized data-exchange protocols, such as the ISO 20022 standard for electronic data exchange between financial institutions. Further, and based on elements of mapping data that characterize a structure, composition, or format of one or more data fields of the ISO-20002-compliant RFP messages, FI computing system 130 may perform any of the exemplary processes described herein to decompose each of the received RFP messages and obtain data characterizing user 101, a corresponding one of the merchants (e.g., the local roofing contractor, the local home-improvement contractor, or the local landscaping company, as described herein), and additionally, or alternatively, the initiated purchase transaction.

For example, the obtained data (e.g., “decomposed field” data) may include one or more of: (i) customer data identifying user 101, such as a unique customer identifier (e.g., a customer name, an alphanumeric login credential, etc.) and a postal address; (ii) payment data characterizing the requested, real-time payment, such as a transaction amount, a requested transaction date or time, an identifier of a product or service involved in the transaction, and an identifier of a customer account selected by user 101 to fund the requested, real-time payment and a merchant account that received proceeds from the requested, real-time payment; (iii) counterparty data identifying the corresponding merchant, such as a counterparty name (e.g., a merchant name, etc.) and postal address; and (iv) transaction data that identifies a value of one or more parameters of corresponding ones of the initiated purchase transactions (e.g., a transaction amount, a transaction date or time, an identifier of one or more of the products or services involved in corresponding ones of the initiated purchase transactions).

Based on the elements of decomposed field data associated with a corresponding one of the received or intercepted RFP messages, FI computing system 130 may perform any of the exemplary processes described herein to approve, or alternatively, decline, an execution of a requested, real-time payment associated with the corresponding RFP message based on an application of one or more execution criteria to the elements of decomposed field data. Further, and based on a decision to decline to execute the requested, real-time payment associated with the corresponding RFP message, FI computing system 130 may also perform any of the exemplary processes described herein to analyze the elements of decomposed field data (e.g., the decomposed elements of customer, counterparty, merchant, transaction, or payment data described herein), and based on the analysis of the elements of message data, to establish that a loan product, such as an unsecured installment loan, is available for provisioning to user 101 and appropriate to fund the declined, real-time payment requested from user 101.

Based on an application of one or more internal qualification or underwriting criteria to data characterizing user 101, and interactions between user 101 and the financial institution or one or more unrelated financial institution, and a use, or misuse, of financial product provisioned by the financial institution of the unrelated financial institutions, executed conversion engine 150 may perform any of the exemplary processes described herein to “pre-approve” user 101 for a provisioning of the available and appropriate loan product in an amount sufficient to fund the declined, real-time payment requested from user 101 by a corresponding merchant. Through a performance of one or more of the exemplary processes described herein, FI computing system 130 may perform operations that “convert” the declined real-time payment into a corresponding, targeted financing offer associated with the pre-approved loan product, which may be provisioned to user 101 via client device 102 in real-time and contemporaneously with the initiation of the corresponding purchase transaction or interception of the RFP message.

To facilitate a performance of one or more of these exemplary processes, FI computing system 130 may maintain, within the one or more tangible, non-transitory memories, a data repository 134 that includes, but is not limited to, a request-for-payment (RFP) queue 135, a candidate financial product data store 136, a mapping data store 138, a customer data store 140, and a real-time payment (RTP) data store 142. RFP queue 135 may include one or more discrete RFP messages received by FI computing system 130 using any of the exemplary processes described herein. In some instances, the RFP messages maintained within RFP queue 135 may be prioritized in accordance with a time or date of receipt by FI computing system 130 or with requested payment data associated with each of the RFP messages, and each of the prioritized RFP messages may be associated with a corresponding temporal pendency. Further, FI computing system 130 may perform any of the exemplary processes described herein to provision elements of notification data associated with each of the RFP messages to a computing system or device associated with a corresponding customer (e.g., client device 102 associated with user 101), and FI computing system 130 may perform operations that maintain each of the RFP messages within RFP queue 135 until a receipt, at FI computing system 130, of confirmation data indicating an approval, or a rejection, of the corresponding requested payment, or until an expiration of the corresponding pendency period.

Candidate financial product data store 136 may include structured or unstructured data that characterizes one or more candidate financial products, such as, but not limited to, one or more of the exemplary loan products described herein, that a customer, such as user 101, may select to fund one or more of the requested, real-time payments associated with corresponding ones of the intercepted or received RFP message. In some instances, the elements of candidate financial product data store 136 may include, for each of the candidate financial products, a unique product identifier (e.g., a product name, etc.), data characterizing terms and conditions for each candidate financial product, and further, data characterizing internal qualification or underwriting procedures for each candidate financial product, as described herein.

Mapping data store 138 may include structured or unstructured data records that maintain one or more elements of field mapping data 138A. For example, and as described herein, FI computing system 130 may receive, obtain, or intercept one or more RFP messages, each of which may be formatted and structured in accordance with a corresponding, standardized data-exchange protocol, such as the ISO 20022 standard for electronic data exchange between financial institutions. In some instances, the one or more elements of field mapping data 138A may characterize a structure, composition, or format of the message data populating one or more data fields of the ISO-20002-compliant RFP messages, or a corresponding RFP message compliant with an additional, or alternate, standardized data-exchange protocol.

Customer data store 140 may include structured or unstructured data records that maintain information identifying and characterizing one or more customers of the financial institution, and further, interactions between these customers and not only the financial institution, but also other unrelated financial institutions and third parties. For example, as illustrated in FIG. 1, customer data store 140 may include one or more elements of profile data 140A, which identify and characterize corresponding ones of the customers of the financial institution, one or more elements of account data 1406, which may identify and characterize one or more accounts held by the customers, one or more elements of transaction data 140C, which identify and characterize prior purchase or payment transactions involving the customers of the financial institution (such as, but not limited to, user 101), and one or more elements of third-party data 140D associated with corresponding customers of the financial institution.

By way of example, for a corresponding one of the customers, such as user 101, the elements of profile data 140A may include, but are not limited to, a customer identifier of user 101 (e.g., an alphanumeric login credential, a customer name, etc.), a postal address of user 101, and values of one or more demographic parameters characterizing user 101 (e.g., a customer age, customer profession, etc.). The accounts held by the customers of the financial institution may include, but are not limited to, a deposit account (e.g., a checking or a savings account issued by the financial institution), a credit-card account, or an account associated with an additional, or alternate, financial product, such as an unsecured personal loan or an installment loan, and the elements of account data 140B may include, for an account held by a corresponding one of the customers, such as user 101, the customer identifier of user 101, all or a portion of an account number (e.g., an actual account number, a tokenized account number, etc.), and data characterizing a status of the account (e.g., a current balance, an overdue balance, length of account existence, etc.) and interactions between user 101 and the account (e.g., amounts and dates of withdrawals, etc.). Further, the elements of transaction data 140C may include the customer identifier of user 101, data identifying one or more prior purchase or payment transactions initiated by user 101 (e.g., a unique, alphanumeric transaction identifier assigned by FI computing system 130), and may include values of transaction parameters that characterize each of the prior purchase or payment transactions, such as a transaction date or time, a transaction amount, an identifier of a corresponding counterparty, or an identifier of an account (e.g., an account number, etc.) that funds, or receives proceeds from, the prior purchase or payment transaction.

The elements of third-party data 140D may, for a corresponding one of the customers, such as user 101, include the customer identifier of user 101 and one or more elements of governmental, judicial, regulatory, or reporting data associated with, and characterizing user 101. By way of example, the elements of third-party data 140D associated with user 101 may include one or more elements of data generated and maintained by a governmental entity (e.g., governmental data) that identifies parcels of real estate, vehicles, or other tangible properties held or owned by user 101. Additionally, or alternatively, the elements of third-party data 140D associated with user 101 may include one or more elements of data generated and maintained by a reporting entity, such as credit-bureau data that includes a credit score or data characterizing one or more credit inquiries associated with user 101 during corresponding temporal intervals. In some examples, FI computing system 130 perform operations that receive, via a secure programmatic channel of communications, one or more of the customer-specific elements of third-party data 140D maintained within customer data store 140 from one or more computing systems associated with corresponding governmental, judicial, regulatory, or reporting entities in accordance with a predetermined temporal schedule, on a continuous, streaming basis, or in response to a requested generated and transmitted by FI computing system 130.

RTP data store 142 may include one or more elements of decomposed field data generated through a decomposition of corresponding ones of the received RFP messages, e.g., based on the elements of field mapping data 138A and through an implementation of any of the exemplary processes described herein. In some instances, the elements of decomposed field data maintained within RTP data store 142 may establish a time-evolving record of real-time payment transactions initiated by, or involving, the user 101 and other customers of the financial institution during a current temporal interval and across one or more prior temporal intervals, and across various merchant classifications or geographic regions.

Further, and to facilitate the performance of any of the exemplary processes described herein, FI computing system 130 may also maintain, within the one or more tangible, non-transitory memories, an application repository 144 that maintains, but is not limited to, a decomposition engine 146, an analytical engine 148, a conversion engine 150, and a notification engine 152, each of which may be executed by the one or more processors of server 132. For example, and upon execution by the one or more processors of FI computing system 130, executed decomposition engine 146 may perform any of the exemplary processes described herein to obtain field mapping data 138A from mapping data store 138, to apply field mapping data 138A to a received, obtained, or intercepted RFP message, and based on the application of field mapping data 130A to the RFP message, to decompose the RFP message and obtain elements of decomposed field data described herein.

Further, and upon execution by the one or more processors of FI computing system 130, executed analytical engine 148 may perform any of the exemplary processes described herein to process the elements of decomposed field data obtained from the message fields of an RFP message, and to approve, or alternatively, decline, an execution of a requested, real-time payment associated with the RFP message based on an application of one or more execution criteria to the elements of decomposed field data. By way of example, the one or more execution criteria may include, but are not limited to, a transaction-specific execution criterion, an account-specific execution criterion, counterparty-specific execution criterion, or a behavior-specific execution criterion, and as described herein, executed analytical engine 148 may determine to approve, or alternatively, decline, the execution of the requested, real-time payments based on a determined consistency, or inconsistency, between each, or a selected subset, of the execution criteria and the elements of decomposed field data, and additionally or alternatively, behavioral data derived from the elements of decomposed field data.

In some instances, upon execution by the one or more processors of FI computing system 130, executed conversion engine 150 may perform any of the exemplary processes described herein to analyze the elements of decomposed field data obtained from the message fields of the RFP message (e.g., the elements of customer, counterparty, merchant, transaction, or payment data described herein), and based on the analysis of the elements of decomposed field data, to establish that a loan product, such as an unsecured installment loan, is available for provisioning to user 101 and appropriate to fund the requested, and declined, real-time payment. Further, and based on an application of one or more internal qualification or underwriting criteria to data characterizing user 101, and interactions between user 101 and the financial institution or one or more unrelated financial institutions, and a use, or misuse, of financial product provisioned by the financial institution of the unrelated financial institutions, executed conversion engine 150 may perform any of the exemplary processes described herein to “pre-approve” user 101 for the loan product in an amount sufficient to fund the requested, and now-declined, real-time payment. Through a performance of one or more of the exemplary processes described herein, FI computing system 130 may perform operations that “convert” the requested, but declined, real-time payment into a corresponding, targeted financing offer associated with the pre-approved loan product, which may be provisioned to user 101 via client device 102 in real-time and contemporaneously with the initiation of the corresponding purchase transaction or interception of the RFP message.

Upon execution by the one or more processors of FI computing system 130, notification engine 152 may perform any of the exemplary processes described herein to generate one or more elements of notification data that include one or more of the information identifying each of the available and pre-approved loan products, the corresponding loan amounts, and the corresponding terms and conditions. In some instances, when provisioned to client device 102 by FI computing system 130, the elements of notification data may cause one or more application programs executed by client device 102 (e.g., mobile banking application 108) to present interface elements within a corresponding digital interface that, among other things, offer each of the available and pre-approved secured credit or loan products to user 101 in accordance with their determined terms and conditions, and that prompt user 101 to accept one or more of the offered secured credit or loan products, which, when provisioned to user 101, may fund one or more of the initiated purchase transactions associated with the received or intercepted RFP messages (e.g., contemporaneously with the initiation of the purchase transactions and the reception or interception of the RFP messages).

### B. Targeted, Criteria-Specific Provisioning of Digital Content Based on Structured Messaging Data

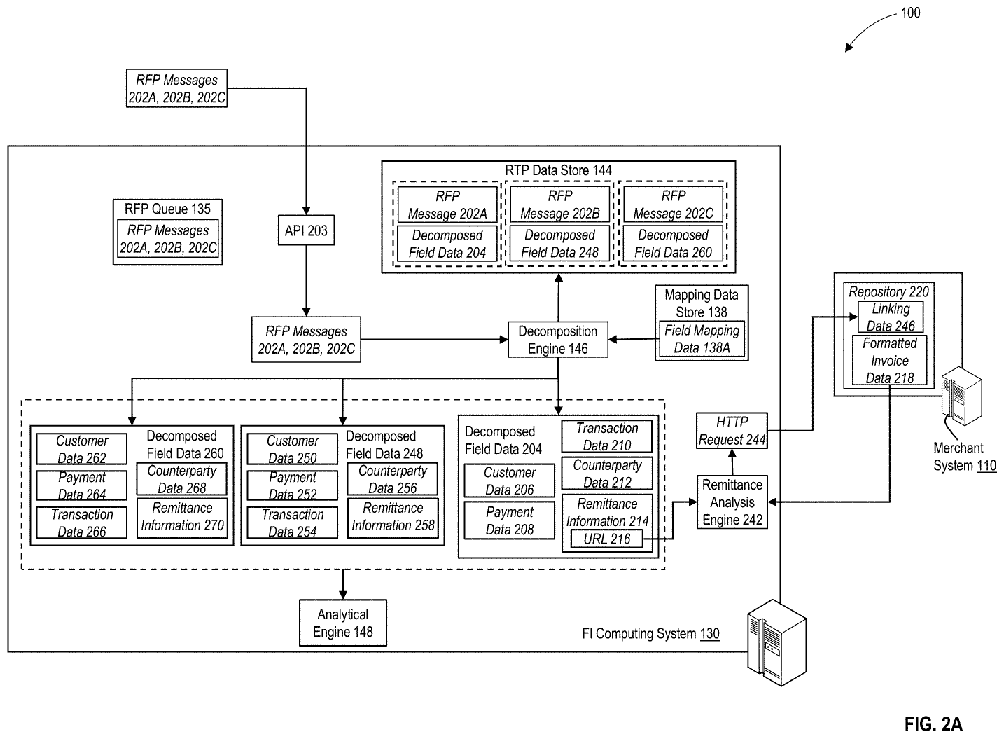

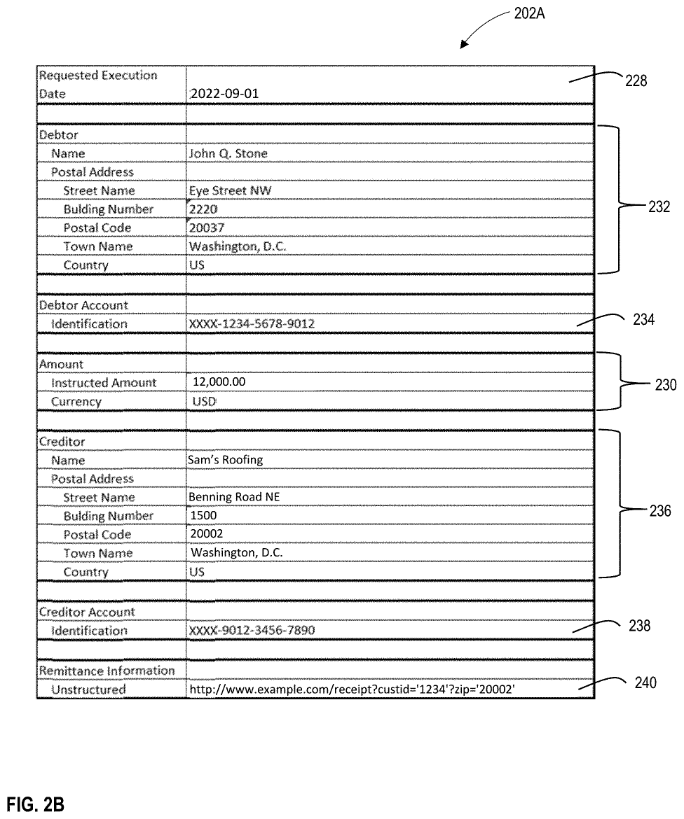

Referring to FIG. 2A, a computing system associated with the financial institution, such as the FI computing system 130, may receive or intercept a plurality of RFP messages identifying and characterizing real-time payments requested from customers of the financial institution, such as, but not limited to, RFP messages 202A, 202B, and 202C. In some instances, each of RFP message 202A, 202B, and 202C may identify and characterize a real-time payment requested from a customer of the financial institution, such as user 101, by a corresponding merchant to fund an initiated purchase transaction involving corresponding products or services. As described herein, each of RFP messages 202A, 202B, and 202C may be structured in accordance with the ISO 20022 standard for electronic data exchange between financial institutions, and in some examples, each of RFP messages 202A, 202B, and 202C may correspond to a pain.013 message as specified within the ISO 20022 standard.

By way of example, a customer of a financial institution, such as user 101, may incur one or more expenses that are unexpected, or that are inconsistent with a prior spending or purchasing pattern of user 101. By way of example, user 101 may maintain a home in the Foggy Bottom neighborhood of Washington, D.C., and during a summer thunderstorm, falling trees and other debris may inflict significant damage to a roof of user 101's home and may damage several windows of user 101's home. In view of the storm damage, user 101 may engage a local roofing contractor (e.g., “Sam's Roofing”) to replace and replace portions of the damaged roof of user 101's home in accordance with an agreed-upon budget (e.g., $12,000.00) with a predetermined, expedited schedule (e.g., on or before Sep. 1, 2022), and may also engage a local home-improvement contractor (e.g., “Lex's Home Improvement”) to replace the damaged windows in accordance with an agreed-upon budget (e.g., $3,200.00) and in accordance with the predetermined, expedited schedule. Further, the recent summer thunderstorm may also result in an accumulation of debris in a yard surrounding user 101's home, and user 101 may engage a local landscaping company (e.g., “Leo's Lawn Care”) to remove the accumulated debris from the yard in accordance with an agreed-upon budget (e.g., $800.00) and in accordance with the predetermined, expedited schedule.

Upon completion of the agreed-upon services in accordance with the predetermined, expedited schedule, one or more computing systems operated by each of the local roofing contractor, the local home-improvement contractor, and the local landscaping company (e.g., a respective one of merchant systems 110, 114, and 118 of FIG. 1), or one more computing systems associated with a financial institution of each the local roofing contractor, the local home-improvement contractor, and the local landscaping company, may generate a corresponding one of RFP messages 202A, 202B, and 202C that requests a real-time payment from user 101 for respective ones of the provisioned roof-repair and roof-replacement services, the provisioned window-replacement services, and the provisioned landscaping services (e.g., the agreed-upon $12,000.00 cost of the provisioned roof-repair and roof-replacement services, the agreed-upon $3,200.00 cost of the provisioned window-replacement services, and the agreed-upon $800.00 cost of the provisioned landscaping services, respectively). In some instances, merchant computing systems 110, 114, and 118 (or the one more computing systems associated with a financial institution of each the local roofing contractor, the local home-improvement contractor, and the local landscaping company) may transmit corresponding ones of RFP messages 202A, 202B, and 202C across a communications network to FI computing system 130, either directly or through one or more intermediate computing systems.

A programmatic interface established and maintained by FI computing system 130, such as application programming interface (API) 208, may receive each of RFP messages 202A, 202B, and 202C, and may route RFP messages 202A, 202B, and 202C to decomposition engine 146 executed by the one or more processors of FI computing system 130. In some examples, FI computing system 130 may receive one or more of RFP messages 202A, 202B, and 202C directly across communications network 120 via a channel of communications established programmatically between API 203 and an executed RTP engine of a corresponding one of merchant systems 110, 114, and 118. Further, in some examples, one or more portions of RFP messages 202A, 202B, and/or 202C may be encrypted (e.g., using a public cryptographic key associated with FI computing system 130), and executed decomposition engine 146 may perform operations that access a corresponding decryption key maintaining within the one or more tangible, non-transitory memories of FI computing system 130 (e.g., a private cryptographic key associated with FI computing system 130), and that decrypt the encrypted portions of RFP messages 202A, 202B, and/or 202C using the corresponding decryption key.

In some instances, executed decomposition engine 146 may store each of RFP messages 202A, 202B, and 202C (in decrypted form) within a corresponding portion of data repository 134 (e.g., within RFP queue 135). Executed decomposition engine 146 may also perform operations that access mapping data store 138 (e.g., as maintained within data repository 134), and obtain one or more elements of field mapping data 138A that characterize a structure, composition, or format of one or more data fields of RFP messages 202A, 202B, and 202C. For example, and as described herein, each of RFP messages 202A, 202B, and 202C may include message fields consistent with the ISO 20022 standard for electronic data exchange between financial institutions, and each of the message fields may be populated with data structured and formatted in accordance with the ISO 20022 standard.

By way of example, and upon completion of the repairs to, and the replacement of, the roof of user 101's home, the one or more computing systems of the local roofing contractor (e.g., merchant computing system 110 of FIG. 1), or the one or more computing systems associated with the financial institution of the local roofing contractor may generate RFP message 202A that requests a real-time payment from user 101 on Sep. 1, 2022, to fund agreed-upon $12,000.00 cost of the provisioned roof-repair and roof-replacement services. In some instances, RFP message 202A may be associated with the $12,000.00 real-time payment requested from user 101 by the local roofing contractor (e.g., “Sam's Roofing”) on Sep. 1, 2022, and referring to FIG. 2B, RFP message 202A may include message field 228 populated with a formatted payment date of Sep. 1, 2022 (e.g., “2022-09-01”), and message fields 230 populated with respective ones of a formatted payment amount (e.g., “12,000.00”) and a formatted payment currency (e.g., “USD”).

RFP message 202A may also maintain, within corresponding ones of message fields 232, a formatted name of user 101 (e.g., “John Q. Stone”) and selected portions of a formatted postal address of user 101 (e.g., “2220 Eye Street NW, Washington, D.C., 20037, US”), and may maintain, within message field 234, a formatted identifier of a financial services account selected by user 101 to fund the $12,000.00 payment to user 101 (e.g., an account number “XXXX-1234-5678-9012” of a deposit account maintained by user 101 and the financial institution). Further, as illustrated in FIG. 2B, message fields 236 of RFP message 202A may be populated, respectively, with a formatted name of the local home-improvement store (e.g., “Sam's Roofing”) and selected portions of a formatted postal address of the local home-improvement store (e.g., “1500 Benning Road NE, Washington, D.C., 20002”). RFP message 202A may also maintain, within message field 238, a formatted identifier of a financial services account held by the local home-improvement store and capable of receiving proceeds from the requested $12,000.00 payment (e.g., an account number “XXXX-9012-3456-7890” of a business checking account held by the local roofing contractor, etc.).

In some instances, RFP message 202A may also include one or more message fields that specify structured or unstructured, remittance information associated with the requested, $12,000.00 real-time payment for provisioned roof-repair and roof-replacement services requested from user 101 by Sam's Roofing on Sep. 1, 2022, such as, but not limited to, a link to invoice data in PDF or HTML format. The formatted invoice data may, for example, include an actual postal address of and contact information for Sam's Roofing, and may also include information identifying and characterizing the provisioned roof-repair and roof-replacement services (e.g., n identifier of the provisioned roof-repair and roof-replacement services, such as a service name, etc.), one or more products associated with the provisioned roof-repair and roof-replacement services (e.g., a product identifier of the boxes of shingles, roofing nails, and sheathing plywood, such as a stock keeping unit (SKU), a universal product code (UPC), a product name, etc.) or the agreed-upon $12,000.00 cost (e.g., total labor costs associated with the provisioned roof-repair and roof-replacement services, total costs for the one or more associated products, a subtotal of the transaction, any applied sales taxes, etc.).

As described herein, the link may include a long-form or shortened URL associated with the formatted invoice data, e.g., that that points to the storage location of formatted invoice data within a data repository maintained by one or more computing systems with the local roofing contractor, such as merchant computing system 110. For example, message field 240 of RFP message 202A may be populated with a long-form URL (e.g., www.example.com/receipt?custid=‘1234’ ?zip=‘20002’) that points to the formatted invoice data maintained within the data repository of merchant computing system 110, and that includes the actual postal code of the local home improvement store (e.g., “20002”) and a customer identifier of user 101 assigned by the local home improvement store (e.g., “1234”).

The disclosed embodiments are, however, not limited to RFP messages populated with these exemplary elements of customer, merchant, payment, transaction, and additional remittance data, and in other examples, RFP message 202A may include any additional, or alternate, message fields specified within field mapping data 138A and consistent with the ISO 20022 standard for electronic data exchange. Further, although not illustrated in FIG. 2B, RFP messages 202B and 202C may also include elements of customer, counterparty, payment, transaction, and additional remittance data, and other elements of data, specified within field mapping data 138A and consistent with the ISO 20022 standard for electronic data exchange. By way of example, the message fields of RFP message 202B may include elements of customer, merchant, payment, transaction, and additional remittance data that characterize a request, from the local home-improvement contractor (e.g., “Lex's Home Improvement”), for a real-time payment from user 101 to fund the agreed-upon $3,200.00 cost of the provisioned window-replacement services on Sep. 1, 2022, and RFP message 202C may include elements of customer, merchant, payment, transaction, and additional remittance data that characterize a request, from the local landscaping company (e.g., “Leo's Lawn Care”), for a real-time payment from user 101 to fund the agreed-upon $800.00 cost of the provisioned landscaping services on Sep. 1, 2022.

Referring back to FIG. 2A, and based on the obtained elements of field mapping data 138A, executed decomposition engine 146 may perform operations that parse RFP message 202A and obtain elements of decomposed field data 204 that identify and characterize the customer (e.g., user 101 of client device 102), the counterparty (e.g., the local home improvement store, “Sam's Roofing”), the requested, real-time payment, and the initiated purchase transaction. In some instances, and through the performance of these exemplary operations, executed decomposition engine 146 may “decompose” the structured or unstructured data populating the message fields of RFP message 202A in accordance with field mapping data 138A, and generate the elements of decomposed field data 204 that include, but are not limited to, one or more elements of customer data 206, payment data 208, transaction data 210, and counterparty data 212.

By way of example, and based on the elements of field mapping data 138A, executed decomposition engine 146 may determine that message fields 232 of RFP message 202A include data that identifies and characterizes user 101, and may perform operations that obtain the customer name of user 101 (e.g., “John Q. Stone”) and the postal address associated with user 101 (e.g., “2220 Eye Street NW, Washington, D.C., 20037, US”) from message fields 232 of RFP message 202A, and that package the obtained customer name and postal address into corresponding portions of customer data 206 of decomposed field data 204. Additionally, and based on the elements of field mapping data 138A, executed decomposition engine 146 may determine that message fields 236 of RFP message 202A includes data identifying and characterizing the local home improvement store, and may perform operations that obtain the name of the local home roofing contractor (e.g., “Sam's Roofing”) and the postal address associated with the local home roofing contractor (e.g., “1500 Benning Road NE, Washington, D.C., 20002”) from message fields 236, and that package the obtained name and postal address of the local home improvement store into corresponding portions of counterparty data 212 within decomposed field data 204.

In some instances, and based on the elements of field mapping data 138A, executed decomposition engine 146 may determine that one or more additional message fields of RFP message 202A include elements of data identifying and characterizing the requested, real-time payment, such as, but not limited to: message field 228, which includes the requested payment date (e.g., “Sep. 1, 2022”); message fields 230, which includes data identifying the payment amount of the requested payment (e.g., $12,000.00) and the requested payment currency (e.g., “USD”); message field 234, which includes an identifier of the payment instrument selected by user 101 to fund the initiated purchase transaction (e.g., the account number “XXXX-1234-5678-9012”); and message field 238, which includes an identifier of an account associated with the local roofing contractor and available of receiving the requested payment (e.g., the tokenized account number “XXXX-9012-3456-7890,” etc.). Executed decomposition engine 146 may perform operations that extract the payment amount, the account identifiers, and the requested payment date from corresponding ones of message fields 228, 230, and 238, and that package the extracted payment amount, the identifiers of the selected payment instrument and the account associated with the local home improvement store, and the requested payment date into corresponding portions of payment data 208.

Further, and based on the elements of field mapping data 138A, executed decomposition engine 146 may also determine that one or more additional, or alternate, message fields of RFP message 202A (not illustrated in FIG. 2B) include elements of transaction data that characterize the purchase transaction initiated between user 101 and the local roofing contractor (e.g., the $12,000.00 purchase of the provisioned roof-repair and roof-replacement services from Sam's Roofing on Sep. 1, 2022). By way of example, the transaction data maintained within the additional, or alternate, message fields of RFP message 202A may include a unique identifier of the provisioned roof-repair and roof-replacement services (e.g., a service name, etc.), a unique identifier of one or more products associated with the provisioned roof-repair and roof-replacement services (e.g., a unique product identifier of the boxes of shingles, roofing nails, and sheathing plywood, such as a stock keeping unit (SKU), a universal product code (UPC), a product name, etc.), the Sep. 1, 2022, transaction date, the total transaction amount of $12,000.00, a subtotal of $11,500.00 for the initiated purchase transaction (including $6,000.00 attributed to labor costs and $5,500.00 attributable to the one or more products), and $500.00 in imposed local sales taxes. In some instances, executed decomposition engine 146 may perform operations that extract the elements of transaction data, such as, but not limited to, the exemplary elements described herein, from corresponding ones of the additional, or alternate, message fields, and package the extracted elements of transaction data into corresponding portions of transaction data 210 of decomposed field data 204.

Executed decomposition engine 146 may also determine, based on the elements of field mapping data 138A, that message field 240 of RFP message 202A includes structured or unstructured elements of remittance data that characterizes further the requested payment, the initiated purchase transaction, user 101, or the local roofing contractor, and executed decomposition engine 146 may obtain the structured or unstructured elements of remittance data from message field 240 of RFP message 202A and package the obtained elements of remittance data into corresponding portions of remittance information 214. In some instances, the elements of structured or unstructured remittance data may include a link (e.g., a shortened or tiny URL, a long-form URL, etc.) to formatted invoice data associated with the requested payment and maintained by a corresponding computing system associated with the local home improvement store, such as merchant computing system 110. For example, the remittance data may include a long-form URL 216 (e.g., www.example.com/receipt?custid=‘1234’ ?zip=20002), that points to formatted invoice data 218 within the one or more tangible, non-transitory memories of merchant computing system 110 (e.g., within data repository 220), and that includes, among other things, the actual postal code of the local home improvement store (e.g., “20002”) and a customer identifier of user 101 (e.g., “1234”).

In some instances, the one or more processors of FI computing system 130 may execute a remittance analysis engine 242, which performs operations that, based on URL 216 maintained within remittance information 214 of decomposed field data 204, programmatically access elements of formatted invoice data 218 maintained within data repository 220 at merchant computing system 110, and that process the accessed elements of formatted invoice data 218 to obtain additional, or alternate, elements of customer data 206, payment data 208, transaction data 210, and counterparty data 212, and that further characterizes the initiated purchase transaction (e.g., the initiated $12,000.00 purchase from Sam's Roofing on Sep. 1, 2022), the provisioned roof-repair and roof-replacement services, or the associated products, such as, but not limited to, one or more of the exemplary elements of customer, payment, transaction, or counterparty data described herein.

For example, executed remittance analysis engine 242 may access URL 216 maintained within remittance information 214, and may process URL 216 and generate a corresponding HTTP request 244 for the elements of formatted invoice data 218 maintained at merchant computing system 110. Executed remittance analysis engine 242 may also perform operations that cause FI computing system 130 to transmit HTTP request 244 across network 120 to merchant computing system 110. Merchant computing system 110 may, for example, receive HTTP request 244, and based on portions of HTTP request 244 and linking data 246 maintained within data repository 220 (e.g., based on a determined match or correspondence between the portions of HTTP request 244 and linking data 246), merchant computing system 110 may perform operations that obtain the elements of formatted invoice data 218 from data repository 220, and that transmit the elements of formatted invoice data 218 across network 120 to FI computing system 130, e.g., as a response to HTTP request 244.

Executed remittance analysis engine 242 may receive the elements of formatted invoice data 218 from merchant computing system 110, and may perform any of the exemplary processes described herein to parse the elements of formatted invoice data 218 (e.g., in a received format, such as a PDF or HTML form, or in a transformed or enhanced format, etc.) and obtain, from the parsed elements of formatted invoice data 218, one or more of the additional, or alternate, elements of customer data 206, payment data 208, transaction data 210, or counterparty data 212 such as, but not limited to, those described herein. By way of example, executed remittance analysis engine 242 may apply one or more optical character recognition (OCR) processes or optical word recognition (OWR) processes to the elements of formatted invoice data 218 in PDF form to generate, or obtain, elements of textual content representative of the data that characterizes user 101, the local roofing contractor, the requested payment, or the initiated purchase of the provisioned roof-repair and roof-replacement services.

By way of example, executed remittance analysis engine 242 may perform operations that detect a presence of one or more keywords within the generated elements of textual content (e.g., “time,” “roofing,” “shingles,” “plywood sheathing, “UPC,” “labor,” “date,” etc.), and may extract elements of the textual content associated with these keywords as corresponding ones of the additional, or alternate, elements of customer data 206, payment data 208, transaction data 210, or counterparty data 212. In other examples, executed remittance analysis engine 242 may detect a presence of the additional, or alternate, elements of customer data 206, payment data 208, transaction data 210, or counterparty data 212 within the generated textual content based on an application of one or more adaptively trained machine learning or artificial intelligence models to portions of the textual content, and examples of these adaptively trained machine learning or artificial intelligence models includes a trained neural network process (e.g., a convolutional neural network, etc.) or a decision-tree process that ingests input datasets composed of all, or selected portions, of the textual content. The disclosed embodiments are, however, not limited to exemplary processes for detecting and extracting one or more of the additional, or alternate, elements of customer data 206, payment data 208, transaction data 210, or counterparty data 212 from the generated textual content, and in other instances, executed remittance analysis engine 242 may perform any additional, or alternate, process for identifying one or more of the additional, or alternate, elements of customer data 206, payment data 208, transaction data 210, or counterparty data 212 within the textual content derived from the processing of the elements of formatted invoice data 218 in PDF format.

Further, and as described herein, the elements of formatted invoice data 218 may be structured in HTML form, and may include metadata that identify and characterize user 101 (e.g., the customer name, etc.), the merchant (e.g., the name or other identifier, etc.), the requested payment (e.g., a payment amount, etc.), or the initiated purchase of the airline tickets. Executed remittance analysis engine 242 may perform operations that detect one or more of the elements of metadata within the elements of formatted invoice data 218, and that obtain, from the elements of metadata, additional, or alternate, elements of customer data 206, payment data 208, transaction data 210, or counterparty data 212, as described herein. The disclosed embodiments are, however, not limited to these exemplary processes for detecting and extracting the additional, or alternate, elements of customer data 206, payment data 208, transaction data 210, or counterparty data 212 from HTML-formatted invoice data 218, and in other instances, executed remittance analysis engine 242 may perform any additional, or alternate, process detecting and obtaining data from the elements of formatted invoice data 218 structured in HTML form, including, but not limited to, an application of one or more screen-scraping processes to elements of formatted invoice data 218 structured in HTML form.

In some instances, executed decomposition engine 146 may perform operations that store decomposed field data 204, which includes the element of customer data 206, payment data 208, transaction data 210, or counterparty data 212, and remittance information 214 (including URL 216), within a corresponding portion of data repository 134, for example, in conjunction with RFP message 202A within a portion of RTP data store 142. Further, and based on the elements of field mapping data 138A, executed decomposition engine 146 may also perform any of the exemplary processes described herein to operations that parse each of RFP messages 202A and 202B, and obtain, respectively, elements of decomposed field data 248 and decomposed field data 260 that identify and characterize the customer (e.g., user 101 of client device 102), a corresponding counterparty (e.g., the local home-improvement contractor, “Lex's Home Improvement,” and the local landscaping company, “Leo's Lawn Care,” respectively), corresponding ones of the requested, real-time payments, and corresponding ones of the initiated purchase transactions.

By way of example, and based on the elements of field mapping data 138A, executed decomposition engine 146 may perform any of the exemplary processes described herein to parse the elements of RFP message 202B, and obtain the customer name, the postal address of user 101, and a name of the local home-improvement contractor (“Lex's Home Improvement”) and a postal address associated with the local home-improvement contractor (e.g., “6201 Arlington Boulevard, Falls Church, Va., 22044, US”), and to package the name and postal address of user 101, and the name and postal address of the local home-improvement contractor, within respective portions of customer data 250 and counterparty data 256 of decomposed field data 248. Further, and based on the elements of field mapping data 138A, executed decomposition engine 146 may perform any of the exemplary processes described herein to obtain, from one or more additional message fields of RFP message 202B, the requested payment date (e.g., “Sep. 1, 2022”), the requested payment amount (e.g., $3,200.00) and the requested payment currency (e.g., “USD”), an identifier of the payment instrument selected by user 101 to fund the requested, real-time payment (e.g., the account number “XXXX-1234-5678-9012” of the deposit account), and an identifier of an account associated with the local home-improvement contractor available to receive proceeds from the requested, real-time payment, and executed decomposition engine 146 available of receiving the requested payment. As described herein, executed decomposition engine 146 may perform operations that package the requested payment date, the requested payment amount (and the requested payment currency), and the identifiers of the payment instrument of user 101 and the account of the local home-improvement contractor within corresponding portions of payment data 252 of decomposed field data 248.

Executed decomposition engine 146 may also perform any of the exemplary processes described herein that, based on the elements of field mapping data 138A, obtain elements of transaction data that characterize the initiated purchase transaction (e.g., the $3,200.00 purchase transaction involving the provisioned window-replacement services initiated on Sep. 1, 2022 by Lex's Home Improvement), and that package the obtained elements of transaction data within corresponding portions of transaction data 254 of decomposed field data 248. Further, executed decomposition engine 146 may also determine, based on the elements of field mapping data 138A, that one or more message fields of RFP message 202B includes structured or unstructured elements of remittance data that further characterize the requested payment, the initiated transaction, user 101, or the local home-improvement contractor, and executed decomposition engine 146 may obtain the structured or unstructured elements of remittance data from the one or more message fields of RFP message 202B and package the obtained elements of remittance data into corresponding portions of remittance information 258 of decomposed field data 248.

As described herein, the structured or unstructured elements of remittance data maintained within the message fields of RFP message 202B may include a link (e.g., a shortened or tiny URL, a long-form URL, etc.) to formatted invoice data associated with the requested $2,000.00 payment and maintained by a corresponding computing system associated with the local home-improvement contractor, such as merchant system 114. In some instances, executed remittance analysis engine 242 may perform any of the exemplary processes described herein to programmatically access the elements of formatted invoice data associated with the requested $3,200.00 payment that are maintained at merchant system 114, to process the formatted invoice data (e.g., in PDF or HTML form), and to obtain one or more additional, or alternate, elements of customer data 250, payment data 252, transaction data 254, or counterparty data 256. As described herein, the additional, or alternate, elements of customer data 250, payment data 252, transaction data 254, or counterparty data 256 may include, but are not limited to, one or more unique identifiers of the provisioned window-replacement services (e.g., a service name, etc.), a unique identifier of one or more products associated with the provisioned window-replacement services (e.g., a unique product identifier of the replacement windows and supporting hardware, such as a stock keeping unit (SKU), a universal product code (UPC), a product name, etc.), the Sep. 1, 2022, transaction date, the total transaction amount of $3,200.00, a subtotal of $3,000.00 for the initiated purchase transaction (including a $2,000.00 cost for three replacement windows and $1,000.00 in labor costs to remove the damaged windows and install the replacement windows), and $200.00 in applied local sales taxes.

Further, and based on the elements of field mapping data 138A, executed decomposition engine 146 may also perform any of the exemplary processes described herein to parse the elements of RFP message 202C, and obtain the customer name, the postal address of user 101, and a name of the local landscaping company (“Leo's Lawn Care”) and a postal address associated with the local home-improvement contractor (e.g., “1401 New York Avenue N.E., Washington, D.C. 20002 US), and to package the name and postal address of user 101, and the name and postal address of the local landscaping company, within respective portions of customer data 262 and counterparty data 268 of decomposed field data 260. Further, and based on the elements of field mapping data 138A, executed decomposition engine 146 may perform any of the exemplary processes described herein to obtain, from one or more additional message fields of RFP message 202C, the requested payment date (e.g., “Sep. 1, 2022”), the requested payment amount (e.g., $800.00) and the requested payment currency (e.g., “USD”), an identifier of the payment instrument selected by user 101 to fund the requested, real-time payment (e.g., the account number “XXXX-1234-5678-9012” of the deposit account), and an identifier of an account associated with the local landscaping company and available to receive proceeds from the requested, real-time payment. As described herein, executed decomposition engine 146 may perform operations that package the requested payment date, the requested payment amount (and the requested payment currency), and the identifiers of the payment instrument of user 101 and the account of the local home-improvement contractor within corresponding portions of payment data 264 of decomposed field data 248.

Executed decomposition engine 146 may also perform any of the exemplary processes described herein that, based on the elements of field mapping data 138A, obtain, from the message fields of RFP message 202C, elements of transaction data that characterize the initiated purchase transaction (e.g., the $800.00 purchase transaction involving the provisioned landscaping services initiated on Sep. 1, 2022., by Leo's Lawn Care), and that package the obtained elements of transaction data within corresponding portions of transaction data 266 of decomposed field data 260. Further, executed decomposition engine 146 may also determine, based on the elements of field mapping data 138A, that one or more message fields of RFP message 202C include structured or unstructured elements of remittance data that further characterize the requested payment, the initiated transaction, user 101, or the local landscaping company, and executed decomposition engine 146 may obtain the structured or unstructured elements of remittance data from the one or more message fields of RFP message 202C and package the obtained elements of remittance data into corresponding portions of remittance information 270 of decomposed field data 260.

By way of example, the structured or unstructured elements of remittance data maintained within the message fields of RFP message 202C may include a link (e.g., a shortened or tiny URL, a long-form URL, etc.) to formatted invoice data associated with the requested $800.00 payment and maintained by a corresponding computing system associated with the local landscaping company, such as merchant system 118. In some instances, executed remittance analysis engine 242 may perform any of the exemplary processes described herein to programmatically access the elements of formatted invoice data associated with the requested $800.00 payment that are maintained at merchant system 118, to process the formatted invoice data (e.g., in PDF or HTML form), and to obtain one or more additional, or alternate, elements of customer data 262, payment data 264, transaction data 266, or counterparty data 268. As described herein, the ad additional, or alternate, elements of customer data 262, payment data 264, transaction data 266, or counterparty data 268 may include, but are not limited to, one or more identifiers of the provisioned landscaping services (e.g., a service name, a textual description of the provisioned landscaping services (such as a removal of debris from user 101's lawn), etc.), a unique identifier of one or more products associated with the provisioned landscaping services (e.g., a unique product identifier of fuel, tools, and other supplies, such as a stock keeping unit (SKU), a universal product code (UPC), a product name, etc.), the Sep. 1, 2022, transaction date, the total transaction amount of $800.00, a subtotal of $790.00 for the initiated purchase transaction (including a $690.00 in labor costs to remove the debris from user 101's lawn and $100.00 cost of the associated products), and $10.00 in imposed local sales taxes.

In some instances, executed decomposition engine 146 may perform operations that store decomposed field data 248, which includes the elements of customer data 250, payment data 252, transaction data 254, or counterparty data 256, and remittance information 258, within a corresponding portion of data repository 134, for example, in conjunction with RFP message 202B within a portion of RTP data store 142. Further, executed decomposition engine 146 may also perform operations that store decomposed field data 260, which includes the elements of customer data 262, payment data 264, transaction data 266, or counterparty data 268, and remittance information 270, within a corresponding portion of data repository 134, for example, in conjunction with RFP message 202C within a portion of RTP data store 142. Further, executed decomposition engine 146 may also perform any of the exemplary processes described herein, either alone or in conjunction with executed remittance analysis engine 242, to “decompose” one or more additional, or alternate, RFP messages maintained within RFP queue 135 into corresponding elements of decomposed field data that include corresponding elements of customer data, counterparty data, payment data, transaction data, and remittance information (including elements of contextual data derived from corresponding elements of formatted invoice data), and to store the corresponding elements of decomposed field data within corresponding portions of RTP data store 142.

Executed decomposition engine 146 may also perform operations that provide the elements of decomposed field data associated with one or more of the RFP messages maintained within RFP queue 135, including elements of decomposed field data 204, 248, and 260 associated with corresponding ones of RFP messages 202A, 202B, and 202C, as inputs to analytical engine 148 executed by the one or more processors of FI computing system 130. Upon execution by the one or more processors of FI computing system 130, executed analytical engine 148 may perform any of the exemplary operations described herein to process the elements of decomposed field data obtained from the message fields of one, or more, of RFP messages 202A, 202B, and 202C received by FI computing system 130 and to and to approve, or alternatively, decline, an execution of the requested, real-time payment associated with corresponding ones of RFP messages 202A, 202B, and 202C.

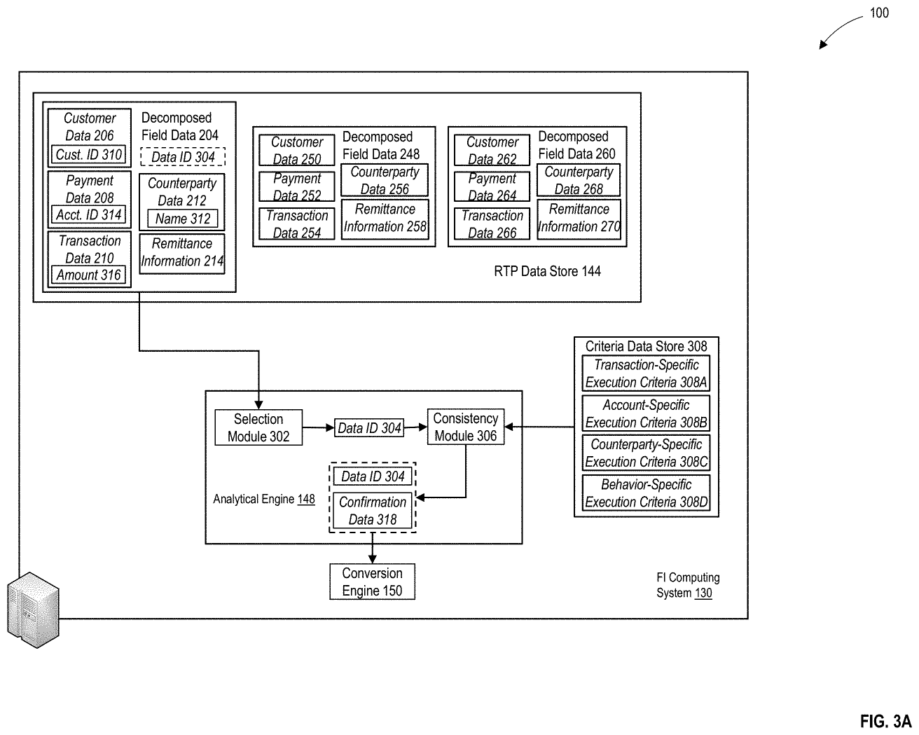

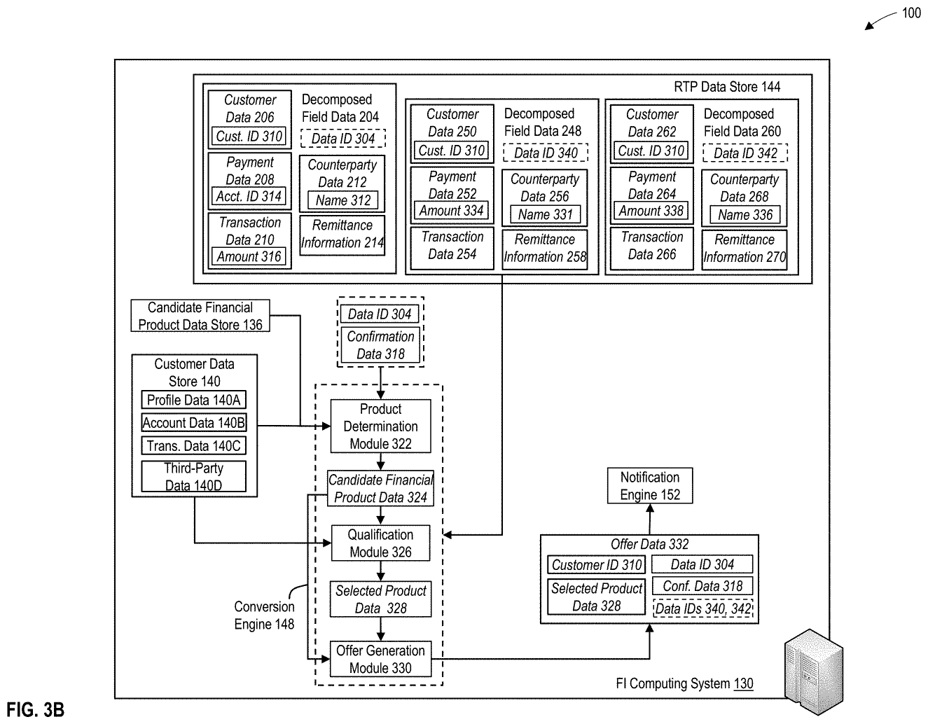

Referring to FIG. 3A, executed analytical engine 148 may access the elements of decomposed field data 204, 248, and 260 maintained within RTP data store 142 (e.g., associated with corresponding ones of RFP messages 202A, 202B, and 202C), and a selection module 302 of executed analytical engine 148 may parse the elements of decomposed field data 204, 248, and 260 and select the requested, real-time payment associated with a corresponding one of RFP messages 202A, 202B, and 202C for approval processing using any of the exemplary processes described herein. By way of example, FI computing system 130 may receive each of RFP messages 202A, 202B, and 202C within a corresponding, prior temporal interval, such as within a five-minute temporal interval, and FI computing system 130 may receive, and store within RFP queue 135, RFP messages 202B and 202C subsequent to the receipt and queuing of RFP message 202A (e.g., RFP message 202A may be associated with a temporal pendency within RFP queue 135 than RFP messages 202B and 202C). In some instances, and based on the temporal pendency of RFP message 202A within RFP queue 135, executed selection module 302 may select the real-time payment of $12,000.00 requested from user 101 by Sam's Roofing on Sep. 1, 2022 (e.g., characterized by the elements of decomposed field data 204) for approval processing using any of the exemplary processes described herein.

In some instances, and based on the selection of the real-time payment of $12,000.00 requested from user 101 by Sam's Roofing on Sep. 1, 2022, for execution, executed selection module 302 may obtain a unique identifier 304 of the elements of decomposed field data 204 maintained within RTP data store 142 and additionally, of corresponding RFP message 202A maintained within RTP data store 142, and may provide identifier 304 as an input to a consistency module 306 of executed analytical engine 148. For example, identifier 304 may include, but is not limited to, data pointing to a storage location of the elements of decomposed field data 204 within RTP data store 142 or a unique alphanumeric identifier assigned to RFP message 202A and/or decomposed field data 204 by FI computing system 130, which FI computing system 130 may maintain, within RTP data store 142, in associated with RFP message 202A and decomposed field data 204.

Executed consistency module 306 may receive identifier 304, and based on identifier 304, executed consistency module 306 may perform operations that access the elements of decomposed field data 204, including the elements of customer data 206, payment data 208, transaction data 210, and counterparty data 212 described herein, maintained within RTP data store 142. Further, as illustrated in FIG. 3A, executed consistency module 306 may also perform operations that access a criteria data store 308 maintained within the one or more tangible, non-transitory memories of FIG. computing system 130, e.g., within a portion of data repository 134. As described herein, criteria data store 308 may include one or more structured or unstructured data records that maintain corresponding ones of a plurality of execution criteria that, when applied to the elements of decomposed field data 204 by executed consistency module 306, enable executed consistency module 306 to approve, or alternatively, reject an execution of requested, real-time payment associated with RFP message 202A (e.g., the real-time payment of $12,000.00 requested from user 101 by Sam's Roofing on Sep. 1, 2022) based on a determined consistency, or alternatively, a determined inconsistency, between, each, or a selected subset, of the execution criteria specified within the data records of criteria data store 308 and the elements of decomposed field data 204.

In some instances, the structured or unstructured records of criteria data store 308 may maintain, among other things, transaction-specific execution criteria 308A, account-specific execution criteria 308B, counterparty-specific execution criterion 308C, and behavior-specific execution criteria 308D. For example, one or more of transaction-specific execution criteria 308A may establish a maximum transaction amount for an initiated purchase transaction associated with a requested, real-time payment and may indicate (or specify) an execution of the requested, real-time payment when a corresponding transaction amount of the initiated purchase transaction fails to exceed the maximum transaction value. Further, in some examples, one or more of account-specific execution criteria 308B may indicate (or specify) an execution of a requested, real-time payment funded by a particular payment instrument (e.g., the deposit account selected by user 101 to fund the real-time payments requested by RFP messages 202A, 202B, and 202C, etc.) when a transaction amount of a corresponding initiated purchase transaction exceeds a maximum transaction amount associated with the particular payment instrument, or when the transaction amount of the corresponding initiated purchase transaction fails to exceed a current daily balance associated with the particular payment instrument, and/or a time-averaged balance associated with the particular payment instrument (e.g., a seven-day rolling average).

Additionally, one or more of counterparty-specific execution criterion 308C may, for example, prohibit an execution of a real-time payment requested by a particular counterparty to a corresponding initiated purchase transaction (e.g., a particular counterparty associated with a corresponding counterparty name or counterparty identifier), or a real-time payment requested by a particular type or class of counterparty (e.g., a particular counterparty characterized by one or more specified standard industrial classification (SIC) codes or one or more specified merchant classification codes (MCCs)). Further, and by way of example, one or more of behavior-specific execution criteria 308D indicate (or specify) an execution of a requested, real-time payment associated with a corresponding, initiated purchase transaction and funded by a particular payment instrument (e.g., the deposit account selected by user 101 to fund the real-time payments requested by RFP messages 202A, 202B, and 202C, etc.) when a current transaction velocity associated with the particular payment instrument fails to exceed a threshold transaction velocity, or when a transaction amount of the corresponding, initiated purchase transaction fails within a specified, threshold amount of an average transaction amount of those purchase transactions initiated by user 101 or funded by the particular payment instrument across a corresponding temporal interval. The disclosed embodiments are, however, not limited to these exemplary transaction-, account-, counterparty-, or behavior-specific execution criteria, and in other instances, the structured or unstructured data records of criteria data store 308 may maintain any additional, or alternate, execution criteria appropriate to user 101, the financial institution associated with FI computing system 130, or the real-time payments requested by RFP messages 202A, 202B, and 202C.

As illustrated in FIG. 3A, executed consistency module 306 may access customer data 206 within decomposed field data 204 and obtain a customer identifier 310 associated with user 101, such as, but not limited to, the alphanumeric customer identifier assigned to user 101 by a merchant computing system 110 and uniquely identifying user 101 at merchant computing system 110 (e.g., alphanumeric customer identifier “1234,” as described herein). Executed consistency module 306 may also access counterparty data 212 of decomposed field data 204, and obtain a name 312 of the merchant associated with merchant computing system 110 (e.g., the merchant name “Sam's Roofing”). Further, executed consistency module 306 may perform operations that obtain, from corresponding ones of payment data 208 and transaction data 210, an account identifier 314 of the payment instrument selected by user 101 to fund the requested, real-time payment associated with RFP message 202A (e.g., the tokenized the account number “XXXX-1234-5678-9012” of the deposit account held by user 101) and a transaction amount 316 of the initiated purchase transaction associated with the requested, real-time payment (e.g., the $12,000 transaction amount). In some instances, and based on customer identifier 310, merchant name 312, account identifier 314, and transaction amount 316, executed consistency module 306 may establish a consistency, or alternatively, an inconsistency, of the execution of the real-time payment of $12,000.00 requested from user 101 by Sam's Roofing on Sep. 1, 2022 (e.g., characterized by RFP message 202A) with one or more of transaction-specific execution criteria 308A, account-specific execution criteria 308B, counterparty-specific execution criterion 308C, and behavior-specific execution criteria 308D, as described herein.

For example, transaction-specific execution criteria 308A may specify, among other things, a maximum transaction amount of $20,000.00 for real-time payments requested from customers of the financial institution, and account-specific execution criteria 308B may specify an account-specific, maximum transaction amount of $10.000.00 for real-time payments funded by the deposit account associated with account identifier 314. Executed consistency module 306 may determine that the $12,000.00 transaction amount specified by transaction amount 316 fails to exceed the $20,000.00 maximum transaction amount specified within transaction-specific execution criteria 308A, and but exceeds the account-specific, maximum transaction amount of $10,000.00 specified within account-specific execution criteria 308B. In some instances, executed consistency module 306 may establish that an execution of the real-time payment of $12,000.00 requested from user 101 by Sam's Roofing on Sep. 1, 2022 would be consistent with transaction-specific execution criteria 308A, but would be inconsistent with account-specific execution criteria 308B,

Executed consistency module 306 may also establish that counterparty-specific execution criteria 308B fails to include merchant name 312 (e.g., “Sam's Roofing”), and as such, executed consistency module 306 may establish a consistency between counterparty-specific execution criteria 308C and an execution of the real-time payment of $12,000.00 requested from user 101 by Sam's Roofing on Sep. 1, 2022. Further, executed consistency module 306 may access the data records of account data 140B and transaction data 140C maintained within customer data store 140, and identify one or more of the data records that are associated with user 101 (and include or reference customer identifier 310) and the deposit account selected by user 101 to fund the requested real-time payment (e.g., as specified within account identifier 314). Based on the identified data records of account data 140B and transaction data 140C, executed consistency module 306 may perform operations that compute a current transaction velocity associated with the selected deposit account exceeds the threshold transaction velocity specified by behavior-specific execution criteria 308D for the selected deposit account. As such, executed consistency module 306 may establish that an execution of the real-time payment of $12,000.00 requested from user 101 by Sam's Roofing on Sep. 1, 2022, would be inconsistent with behavior-specific execution criteria 308D.

Based on the determined inconsistencies between the execution of the real-time payment of $12,000.00 requested from user 101 by Sam's Roofing on Sep. 1, 2022, and one of more of account-specific execution criteria 308B and behavior-specific execution criteria 308D, executed consistency module 306 may decline to execute the real-time payment of $12,000.00 requested from user 101 by Sam's Roofing on Sep. 1, 2022 (e.g., as associated with RFP message 202A and as characterized by the elements of decomposed field data 204). Executed consistency module 306 may perform operations that generate one or more elements of confirmation data 318 that characterize the declined execution of the real-time payment of $12,000.00 requested from user 101 by Sam's Roofing on Sep. 1, 2022.

Although not illustrated in FIG. 3A, executed analytical engine 148 may perform operations that trigger an execution of notification engine 152 (e.g., based on a programmatic signal generated by executed analytical engine 148), and that provision identifier 304 and the one or more elements of confirmation data 318 to executed notification engine 152, which may process the one or more elements of confirmation data 318 and generate an additional, ISO-20022-compliant message, such as an ISO-20022-compliant error message, that confirms the decision to decline the execution of the requested real-time payment, e.g., based on the determined inconsistencies between the execution of the real-time payment of $12,000.00 requested from user 101 by Sam's Roofing on Sep. 1, 2022, and one of more of account-specific execution criteria 308B and behavior-specific execution criteria 308D. Executed notification engine 152 may also perform operations (not illustrated in FIG. 3A) that cause FI computing system 130 to broadcast the ISO-20022-compliant error message across network 120 to merchant computing system 110, either directly or through one or more of the intermediate systems described herein (e.g., such as a clearinghouse system or a computing system of a financial institution of Sam's Roofing), and that delete RFP message 202A from RFP queue 135.

In other instances, and responsive to the decision to decline the execution of the real-time payment of $12,000.00 requested from user 101 by Sam's Roofing on Sep. 1, 2022, executed analytical engine 148 may perform operations that trigger an execution of conversion engine 150 (e.g., based on a programmatic signal generated by executed analytical engine 148), and that provision the one or more elements of confirmation data 318, and identifier 304 of the elements of decomposed field data 204 (e.g., that characterize requested, real-time payment of $12,000.00 associated with RFP message 202A), to executed conversion engine 150. Executed conversion engine 150 may perform any of the exemplary processes described herein to establish that a loan product, such as an unsecured installment loan, is available for provisioning to user 101 and appropriate to fund the requested, real-time payment of $12,000.00 associated with RFP message 202A, and additionally, or alternatively, one or more requested, real-time payments associated with RFP messages received by FI computing system 130 during a prior temporal interval, such as, but not limited to, RFP messages 202B and 202C.

Based on an application of one or more internal qualification or underwriting criteria to data characterizing user 101, and interactions between user 101 and the financial institution or one or more unrelated financial institution, and a use, or misuse, of financial product provisioned by the financial institution of the unrelated financial institutions, executed conversion engine 150 may perform any of the exemplary processes described herein to “pre-approve” user 101 for the loan product in an amount sufficient to fund the requested, real-time payment of $12,000.00 (and in some instances, the requested real-time payments of $3,200.00 and $800.00 associated with RFP messages 202B and 202C, respectively). Through a performance of one or more of the exemplary processes described herein, FI computing system 130 may perform “convert” the now-declined real-time payment of $12,000.00 (and in some instances, the requested, and pending, real-time payments of $3,200.00 or $800.00) into a corresponding, targeted financing offer associated with the pre-approved loan product, which may be provisioned to user 101 via client device 102 in real-time and contemporaneously with the initiation of the corresponding purchase transaction or interception of RFP message 202A.

Referring to FIG. 3B, executed conversion engine 150 may receive identifier 304 of the elements of decomposed field data 204 (e.g., that characterize requested, real-time payment of $12,000.00 associated with RFP message 202A) and the elements of confirmation data 318 (e.g., that confirm the decision to decline the execution of the requested, real-time payment of $12,000.00 associated with RFP message 202A). As described herein, identifier 304 may include, but is not limited to, data pointing to a storage location of the elements of decomposed field data 204 within RTP data store 142 or a unique alphanumeric identifier assigned to RFP message 202A and/or decomposed field data 204 by FI computing system 130, which FI computing system 130 may maintain, within RTP data store 142, in associated with RFP message 202A and decomposed field data 204.

Based on the determined decision to decline the execution of the requested, real-time payment of $12,000.00 associated with RFP message 202A, a product determination module 322 of executed conversion engine 150 may perform operations that access the elements of decomposed field data 204, including the elements of customer data 206, payment data 208, transaction data 210, and counterparty data 212 described herein, maintained within RTP data store 142 based on identifier 304. As described herein, the elements of customer data 206, payment data 208, transaction data 210, and counterparty data 212 may identify and characterize user 101, the local roofing contractor (e.g., “Sam's Roofing”), and the real-time payment of $12,000.00 requested from user 101 by Sam's Roofing on Sep. 1, 2022, and executed product determination module 322 may access candidate financial product data store 136 and, identify one or more of the candidate financial products appropriate to fund at least the real-time payment of $12,000.00 requested from user 101 by Sam's Roofing on Sep. 1, 2022. In some instances, executed product determination module 322 may obtain information that identifies and characterizes each of the identified candidate financial products from candidate financial product data store 136, and the obtained information may, for each of the candidate financial products, include a corresponding product identifier (e.g., a product name or an alphanumeric identifier, etc.) and one or more internal qualification or underwriting criteria that establish an availability of the candidate financial product to user 101 and enable the financial institution to establish purchase-, merchant, and/or customer-specific terms and conditions.

The internal qualification or underwriting criteria may include, for example, a minimum average monthly balance in one or more deposit accounts, an average payroll deposit amount received by user 101's financial accounts on a daily, weekly, yearly, or monthly basis, and additionally, or alternatively, an average amount saved by user 101 (e.g., as a difference between the payroll deposit amount and the payment amounts over a particular temporal interval) for that candidate financial product. For each of the candidate financial products, executed product determination module 322 may generate candidate financial product data 324 identifying and charactering the corresponding candidate financial product and, additionally or alternatively, the one or more internal qualification criteria, including any of the corresponding purchase-, merchant, and/or customer-specific terms and conditions.

In some instances, executed product determination module 322 may perform operations that access one or more of customer data 206, payment data 208, transaction data 210, and counterparty data 212 within decomposed field data 204 to determine an availability of a particular candidate financial product to user 101. For example, executed product determination module 322 may perform operations that access the payment data 208 with decomposed field data 204, and determine a payment amount (e.g., the $12,000.00) for the requested, real-time payment associated with RFP message 202A. Based on the payment amount, executed product determination module 322 may determine that one or more of the candidate financial products characterized within candidate financial product data store 136 are appropriate to fund the requested and now-declined, real-time payment of $12,000.00, and may, additionally or alternatively, determine that one or more other candidate financial products characterized within candidate financial product data store 136 are inappropriate to fund the requested, but declined, real-time payment. For example, and to be available to fund the requested, and declined, real-time payment, each candidate financial product, including the candidate loan products described herein, may be associated with a minimum loan amount disposed at, or above, a threshold value (e.g., the $12,000.00 payment amount of the requested payment).

Executed product determination module 322 may also perform operations that determine an appropriateness of a particular candidate financial product to fund the requested, and now-declined, real-time payment based on accessed elements of counterparty data 212 maintained within decomposed field data 204. For example, a candidate financial product, such as a candidate loan product, may associated with, and may be available to fund purchases involving, a particular merchant, and executed product determination module 322 may obtain a merchant name 312 (e.g., “Sam's Roofing”) from counterparty data 212, and based on merchant name 312, executed product determination module 322 may determine the availability of the candidate financial product to fund payments requested by particular merchant (e.g., “Sam's Roofing”).

Further, in some examples, executed product determination module 322 may perform operations that apply a trained machine learning or artificial intelligence process to an input dataset obtained, or extracted from, elements of decomposed field data 204 (including the elements of customer data 206, payment data 208, transaction data 210, and counterparty data 212), elements of profile data 140A, account data 140B, transaction data 140C, and third-party data 140D associated with user 101, and/or data characterizing one or more candidate financial products maintained within candidate financial product data store 136. Based on the application of the trained machine learning or artificial intelligence process to the input dataset, executed product determination module 322 may generate output data that identifies a candidate financial product appropriate to fund at least the real-time payment of $12,000.00 requested from user 101 by Sam's Roofing on Sep. 1, 2022, which FI computing system 130 declined to execute in accordance with the elements of decomposed field data 204. Executed product determination module 322 may also perform operations, described herein, to package data identifying and charactering the identified candidate financial product and, additionally or alternatively, the one or more internal qualification criteria, into portions of candidate financial product data 324.

Examples of the trained machine-learning and artificial-intelligence processes may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The trained machine-learning and artificial-intelligence processes may also include, among other things, a decision tree process (e.g., a boosted decision tree algorithm, etc.), a random decision forest, an artificial neural network, a deep neural network, or an association-rule process (e.g., an Apriori algorithm, an Eclat algorithm, or an FP-growth algorithm). Further, and as described herein, each of these exemplary machine-learning and artificial-intelligence processes may be trained against, and adaptively improved using, elements of training and validation data, and may be deemed successfully trained and ready for deployment when a value of one or more performance or accuracy metrics are consistent with one or more threshold training or validation criteria.

For instance, the additional trained machine learning or artificial intelligence process may include a trained decision-tree process, and executed product determination module 322 may obtain, from one or more tangible, non-transitory memories of FI computing system 130, elements of process input data and process parameter data associated with the trained decision-tree process, such as those described herein (not illustrated in FIG. 3B). In some examples, not illustrated in FIG. 3B, executed product determination module 322 may perform operations that generate one or more discrete elements (e.g., “feature values”) of the input dataset in accordance with the elements of process input data. Based on portions of the process parameter data, executed product determination module 322 may perform operations that establish a plurality of nodes and a plurality of decision trees for the trained decision-tree process, each of which receive, as inputs (e.g., “ingest”), corresponding elements of the input dataset. Upon ingestion of the input dataset by the established nodes and decision trees of the trained decision-tree process, executed product determination module 322 may perform operations that apply the additional, trained decision-tree process to the input dataset, and that generate the output data that identifies the candidate financial product appropriate to fund at least the declined, real-time payment of $12,000.00 requested from user 101 by Sam's Roofing on Sep. 1, 2022.

Referring back to FIG. 3B, executed product determination module 322 may provide candidate financial product data 324, which characterizes the one or more available candidate financial products, as an input to a qualification module 326 of executed conversion engine 150. Executed qualification module 326 may, for example, receive candidate financial product data 324, and may perform further operations that access customer data 206 within decomposed field data 204 and obtain customer identifier 310 associated with user 101. By way of example, customer identifier 310 may include the alphanumeric customer identifier assigned to user 101 by merchant computing system 110 and uniquely identifying user 101 at merchant computing system 110 (e.g., alphanumeric customer identifier “1234,” as described herein), and in some instances, executed qualification module 326 may access the elements of profile data 140A maintained within customer data store 140, and perform operation that map customer identifier 310 to a corresponding customer identifier assigned to user 101 by the financial institution associated with FI computing system 130 (e.g., the alphanumeric login credential or customer name described herein).

Executed qualification module 326 may, for example, access customer data store 140, and based on the customer identifier assigned to user 101 by the financial institution, execute qualification module 326 may obtain elements of profile data 140A, account data 140B, and transaction data 140C that are associated with user 101. Further, executed qualification module 326 may also perform operations that, based on the customer identifier assigned to user 101 by the financial institution, obtain additional data that characterizes user 101, a user of one or more financial services accounts held by user 101, or the interactions between user 101 and the financial institution, such as, but not limited to, elements of reporting or credit-bureau data associated with user 101 and maintained within third-party data 140D.

In some instances, and based on the elements of candidate financial product data 324, executed qualification module 326 may perform additional operations that, for each of the identified candidate financial products, apply corresponding ones of the internal qualification or underwriting criteria to the elements of profile data 140A, account data 140B, and transaction data 140C associated with user 101, and to the elements of reporting or credit-bureau data associated with user 101 and maintained within third-party data 140D, and that generate a corresponding set candidate terms and conditions for each of the identified candidate financial products (e.g., to “pre-approve” user 101 for each of the identified candidate financial products). Based on the candidate terms and conditions, executed qualification module 326 may select one of the identified candidate financial products, and may package portions of candidate financial product data 324 that identify and characterize the selected financial product (e.g., product name, a unique alphanumeric identifier of the selected financial product, etc.), and information identifying the terms and conditions associated with the selected financial product, into corresponding portions of selected product data 328.

For example, the elements of candidate financial product data 324 may identify, and characterize, a loan product, such as an installment loan, that is available for provisioning to user 101 and that is appropriate to fund the now-rejected $12,000.00 real-time payment requested by “Sam Roofing” on Sep. 1, 2022. In some instances, based on an application of the internal qualification or underwriting criteria associated with the installment loan to the elements of profile data 140A, account data 140B, transaction data 140C, and reporting or credit-bureau data associated with user 101, executed qualification module 326 may determine that user 101 is associated with a credit score above a threshold value and that checking account held by user 101 experiences a positive cash flow on a month-over-month basis (e.g., as specified by the associated internal qualification or underwriting criteria), and may establish terms and conditions for the installment loan that include, but are not limited to, a term of one year, an available loan amount of $16,000.00, a zero-percent interest rate, and a monthly payment of $1,333.34 during each month of the one-year term. In some instances, executed qualification module 326 may perform operations that package the elements of candidate financial product data 324 that identify and characterize the available installment loan, and information identifying the terms and conditions, into portions of selected product data 328.

Executed qualification module 326 may provide selected product data 328 as an input to an offer generation module 330 of executed conversion engine 150. As illustrated in FIG. 3B, executed offer generation module 330 may package customer identifier 310 (or the customer identifier assigned to user 101 by the financial institution) and selected product data 328, which includes the elements of candidate financial product data 324 that identify and characterize the available installment loan, and the information identifying the terms and conditions, into corresponding portions of offer data 332, which executed conversion engine 150 may provide as an input to notification engine 152. Executed conversion engine 150 may also package, into corresponding portions of offer data 332 provisioned to notification engine 152, elements of confirmation data 318 (e.g., that characterizes the decision to decline the execution of the real-time payment of $12,000.00 associated with RFP message 202A), and identifier 304 of the elements of decomposed field data 204 associated with RFP message 202A and the now-declined real-time payment requested from user 101 by Sam's Roofing.

As described herein, the available installment loan (e.g., the one-year, zero-interest installment loan in the loan amount of $16,000.00) may be capable of funding the declined, real-time payment of $12,000.00 requested from user 101 by Sam's Roofing on Sep. 1, 2022 (e.g., associated with RFP message 202A within RFP queue 135). Further, and through a performance of one or more of the exemplary processes described herein, FI computing system 130 may perform “convert” the now-declined real-time payment of $12,000.00 into a corresponding, targeted financing offer associated with the available installment loan, which may be provisioned to user 101 via client device 102 in real-time and contemporaneously with the initiation of the corresponding purchase transaction, the interception of RFP message 202A, or the determination to decline any execution of the requested, $12,000.00 real-time payment.

Further, as described herein, RFP queue 135 may maintain one or more additional RFP messages associated with real-time payments requested from user 101 by corresponding merchants that participate in the RTP ecosystem, such as, but not limited to RFP message 202B associated with the real-time payment of $3,200.00 requested from user 101 by Lex's Home Improvement on Sep. 1, 2022 (e.g., to fund the unexpected, storm-related, window-replacement services) and RFP message 202C associated with the real-time payment of $800.00 requested from user 101 by Leo's Lawn Care on Sep. 1, 2022 (e.g., to fund the unexpected, storm-related, landscaping services). In some instances, based on the elements of decomposed field data associated with the pending and queued RFP messages (e.g., the elements of decomposed field data 248 and 260 associated with respective ones of RFP messages 202B and 202C), executed conversion engine 150 may also perform operations that establish an availability of the installment loan to fund the requested, real-time payments associated with one, or more, of the pending and queued RFP messages, and that package additional information characterizing the determined availability into corresponding portions of offer data 332.

By way of example, offer generation module 330 of executed conversion engine 150 may perform operations that access the elements of decomposed field data 248 associated with pending and queued RFP message 202B, and that access the elements of decomposed field data 260 associated with pending and queued RFP message 202C. As described herein, RFP message 202B may be associated with a real-time payment of $3,200.00 requested from user 101 by Lex's Home Improvement on Sep. 1, 2022 (e.g., to fund the unexpected, storm-related, window-replacement services), and RFP message 202C may be associated with a real-time payment of $800.00 requested from user 101 by Leo's Lawn Care on Sep. 1, 2022 (e.g., to fund the unexpected, storm-related, landscaping services). Executed offer generation module 330 may perform operations that access decomposed field data 248 associated with RFP message 202B, and obtain a corresponding merchant name 331 (e.g., “Lex's Home Improvement”) from counterparty data 256, and a corresponding payment amount 334 (e.g., $3,200.00) from payment data 252. Further, executed offer generation module 330 may also perform operations that access decomposed field data 260 associated with RFP message 202C, and obtain a corresponding merchant name 336 (e.g., “Leo's Lawn Care”) from counterparty data 268, and a corresponding payment amount 338 (e.g., $800.00) from payment data 264).

In some instances, based on payment amounts 334 and 338, executed offer generation module 330 may perform operations that parse the elements of selected product data 328, and determine that the loan amount of $16,000.00 is sufficient in magnitude to fund not only the declined, real-time payment of $12,000.00 requested from user 101 by Sam's Roofing on Sep. 1, 2022 (e.g., associated with RFP message 202A within RFP queue 135), but also the real-time payment of $3,200.00 requested from user 101 by Lex's Home Improvement on Sep. 1, 2022 (e.g., associated with RFP message 202B within RFP queue 135), and the real-time payment of $800.00 requested from user 101 by Leo's Lawn Care on Sep. 1, 2022 (e.g., associated with RFP message 202B within RFP queue 135). Further, and based on merchant names 332 and 336, executed offer generation module 330 may also perform, described herein, that determine the instalment loan is also appropriate to fund the real-time payments requested by Lex's Home Improvement and Leo's Lawn Care, e.g., based on corresponding elements of candidate financial product data store 136 associated with the installment loan.

Based on a determination that the installment loan is also appropriate to fund the real-time payments requested from user 101 by respective ones of Lex's Home Improvement and Leo's Lawn Care (e.g., associated with corresponding ones of queued and pending RFP messages 202B and 202C), executed offer generation engine 330 may perform operations that package, into corresponding portions of offer data 332, a unique identifier 340 of the elements of decomposed field data 248 associated with the real-time payment of $3,200.00 requested from user 101 by Lex's Home Improvement on Sep. 1, 2022, and a unique identifier 342 of the elements of decomposed field data 260 associated with the real-time payment of $800.00 requested from user 101 by Leo's Lawn Care on Sep. 1, 2022. By way of example, each of identifiers 340 and 342 may include, but is not limited to, data pointing to a storage location of the corresponding ones of the elements of decomposed field data 248 and 260 within RTP data store 142 or a unique alphanumeric identifier assigned to corresponding ones of RFP messages 202B and 202C and/or corresponding elements of decomposed field data 248 and 260 by FI computing system 130, which FI computing system 130 may maintain, within RTP data store 142, in association with RFP message 202B and decomposed field data 248 and with RFP message 202C and decomposed field data 260, respectively. As illustrated in FIG. 3B, executed conversion engine 150 may provision offer data 332, including customer identifier 310, selected product data 328, identifier 304 of decomposed field data 204, confirmation data 318 and in some instances, identifiers 340 and 342 of corresponding elements of decomposed field data 248 and 260, as an input to notification engine 152 executable by the one or more processors of FI computing system 130.

Upon execution by the one or more processors of FI computing system 130, executed notification engine 152 may perform any of the exemplary processes described herein to generate elements of notification data that identify, and characterize, the real-time payment of $12,000.00 requested from user 101 by Sam's Roofing on Sep. 1, 2022 (e.g., to fund the unexpected, storm-related, roof-repair and roof-replacement services), which FI computing system 130 declined to executed due to a determined inconsistency with one, or more, of exemplary execution criteria described herein, and the one-year, interest-free installment loan available to fund the requested, and now-declined, $12,000.00 real-time payment requested from user 101 by Sam's Roofing on September 1^{st}. Further, in some examples, the generated elements of notification data may also specify that an availability of the one-year, interest-free installment loan to fund not only the requested, and now declined, real-time payment of $12,000.00, but also a real-time payment associated with one or more additional RFP messages pending within RFP queue 135 and awaiting processing, such as, but not limited to the real-time payment of $3,200.00 requested from user 101 by Lex's Home Improvement on September 1^{st} (e.g., to fund the unexpected, storm-related, window-replacement services) and the real-time payment of $800.00 requested from user 101 by Leo's Lawn Care, on September 1^{st} (e.g., (e.g., to fund the unexpected, storm-related, landscaping services).

As described herein, when provisioned to client device 102, and when rendered for presentation within a corresponding digital interface (e.g., via display unit 109A), the elements of notification data may offer to fund the requested, and now-declined, real-time payment to Sam's Roofing on Sep. 1, 2022, using the one-year, interest-free installment loan to user 101 in accordance the determined terms and conditions. Further, and as described herein, the presented elements of notification data may also offer to fund the real-time payment associated with one or more additional RFP messages pending within RFP queue 135 and awaiting processing, such as, but not limited to the real-time payment of $3,200.00 requested from user 101 by Lex's Home Improvement on September 1^{st}, and the real-time payment of $800.00 requested from user 101 by Leo's Lawn Care, on September 1^{st}, using proceeds from the available installment loan in accordance the determined terms and conditions (e.g., as an alternative to funding these additional, real-time payments using the deposit account specified within the message fields of queued and pending RFP messages 202B and 202C, respectively). In some instances, the presented elements of notification data prompt user 101 to indicate an acceptance of the offered the one-year, interest-free installment loan based on an approval of a further, real-time payment requested the financial institution of a nominal amount, e.g., a $1.00 real-time payment funded by the deposit account specified within RFP message 202A.

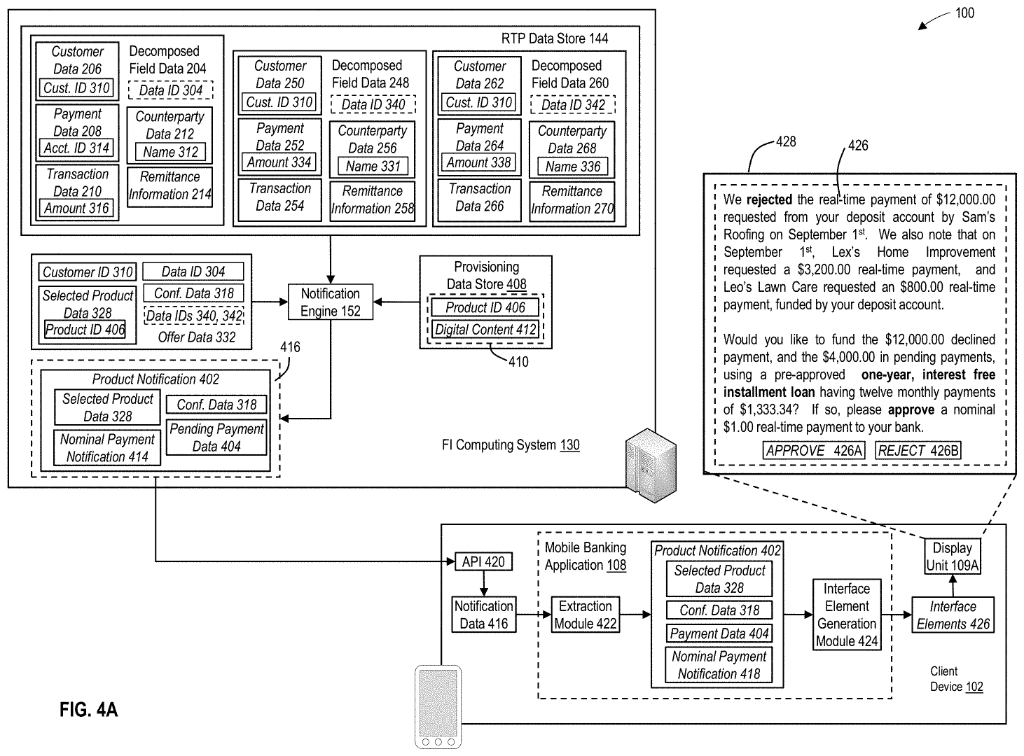

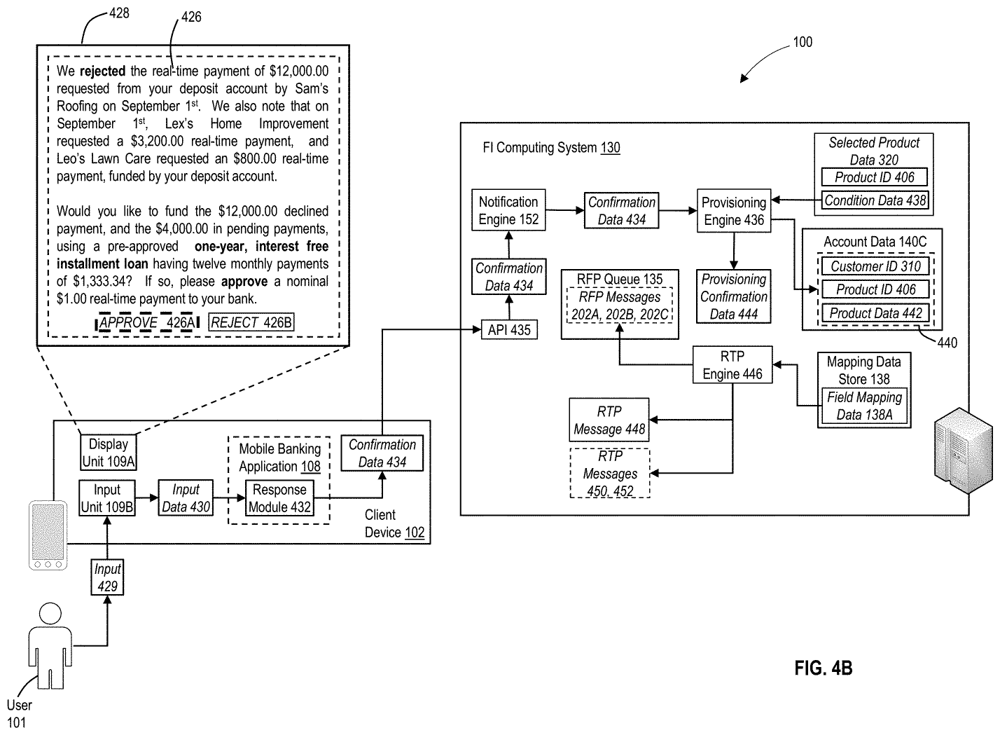

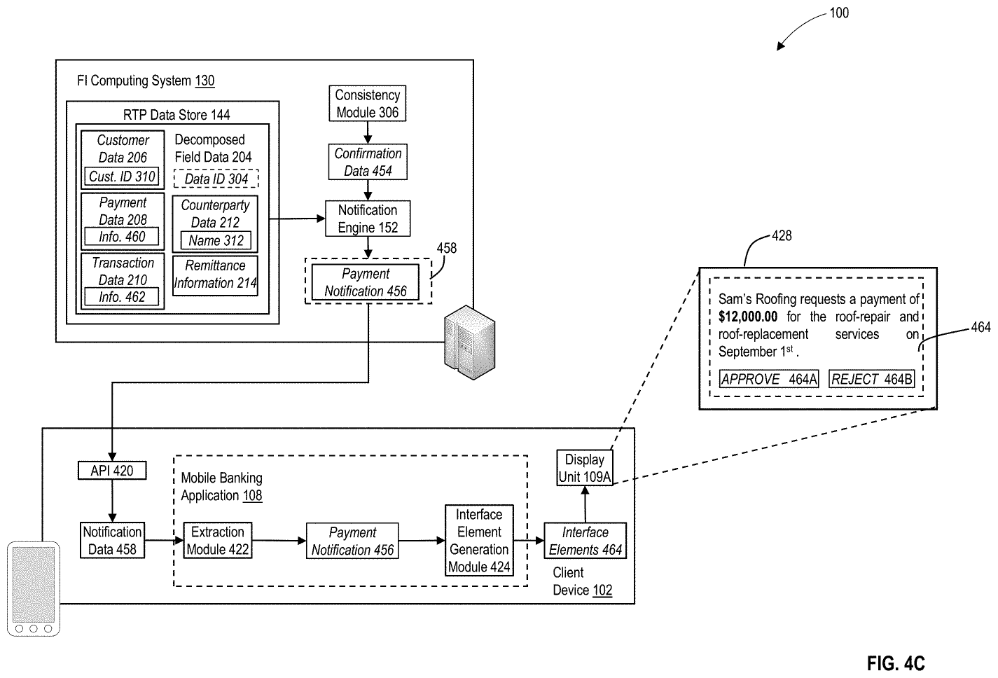

Referring to FIG. 4A, executed notification engine 152 may receive offer data 332, which includes customer identifier 310, selected product data 328, elements of confirmation data 318 (e.g., that characterizes the decision to decline the execution of the real-time payment of $12,000.00 associated with RFP message 202A), and identifier 304 of the elements of decomposed field data 204 associated with RFP message 202A and the now-declined real-time payment requested from user 101 by Sam's Roofing. Further, and as described herein, executed notification engine 152 may also include identifier 340 of the elements of decomposed field data 248 associated with the real-time payment of $3,200.00 requested from user 101 by Lex's Home Improvement on Sep. 1, 2022, and identifier 342 of the elements of decomposed field data 260 associated with the real-time payment of $800.00 requested from user 101 by Leo's Lawn Care on Sep. 1, 2022. Executed notification engine 152 may store offer data 332 within the one or more tangible, non-transitory memories of FI computing system 130, e.g., within a portion of data repository 134 (not illustrated in FIG. 4A).

In some instances, executed notification engine 152 may parse offer data 332 and obtain selected product data 328, which includes the elements of candidate financial product data 324 that identify and characterize the available installment loan, and the information identifying the terms and conditions (e.g., the one-year term, the $16,000.00 loan amount, the zero-percent interest rate, and the monthly payment of $1,333.34, etc.), and executed notification engine 152 may package each, or a selected portion, of the elements of selected product data 328 into a product notification 402. Further, executed notification engine 152 may package all, or a selected portion, of the elements of confirmation data 318, which characterizes the decision to decline the execution of the real-time payment of $12,000.00 requested from user 101 by Sam's Roofing on Sep. 1, 2022, into corresponding portions of product notification 402.

Executed notification engine 152 may also perform operations that access RTP data store 142 and based on identifier 304, and access the elements of decomposed field data 204. As described herein, the elements of decomposed field data 204 may include one or more elements of customer data 206, payment data 208, transaction data 210, and counterparty data 212 extracted from the structured or unstructured message fields of RFP message 202A and, as such, that identify and characterize the real-time payment of $12,000.00 requested from user 101 by Sam's Roofing on Sep. 1, 2022, the execution of which FI computing system 130 declined due to determined inconsistencies with one or more of the exemplary execution criteria described herein. In some instances, not illustrated in FIG. 4A, executed notification engine 152 may also package portions of the accessed elements of customer data 206, payment data 208, transaction data 210, and counterparty data 212 into corresponding portions product notification 402.

Further, and as described herein, the available installment loan may be available to not only fund the real-time payment of $12,000.00 requested from user 101 by Sam's Roofing on Sep. 1, 2022, which FI computing system 130 declined to execute, but also a real-time payment associated with one or more additional RFP messages pending within RFP queue 135 and awaiting processing, such as, but not limited to the real-time payment of $3,200.00 requested from user 101 by Lex's Home Improvement on September 1^{st} (e.g., characterized by the elements of decomposed field data 248) and the real-time payment of $800.00 requested from user 101 by Leo's Lawn Care, on September 1^{st} (e.g., characterized by the elements of decomposed field data 260). In some instances, executed notification engine 152 may obtain identifiers 340 and 342 from offer data 332, and based on identifiers 340 and 342 may access corresponding the elements of corresponding ones of decomposed field data 248 and 260 maintained within RTP data store 142.

By way of example, decomposed field data 248 may include the elements of customer data 250, payment data 252, transaction data 254, or counterparty data 256 that identify and characterize the real-time payment of $3,200.00 requested from user 101 by Lex's Home Improvement on September 1^{st}, and decomposed field data 260 may include the elements of customer data 262, payment data 264, transaction data 266, or counterparty data 268 that identify and characterize the real-time payment of $800.00 requested from user 101 by Leo's Lawn Care, on September 1^{st}. In some instances, executed notification engine 152 may perform operation that package one or more of the elements of customer data 250, payment data 252, transaction data 254, or counterparty data 256 associated with the real-time payment of $3,200.00 requested from user 101 by Lex's Home Improvement, and one or more of the elements of customer data 262, payment data 264, transaction data 266, or counterparty data 268 associated with the real-time payment of $800.00 requested from user 101 by Leo's Lawn Care, into corresponding portions of pending payment data 404, which executed notification engine 152 may package into product notification 402.

Further, executed notification engine 152 may also obtain, from the elements of selected product data 328, a product identifier 406 associated with the available installment loan (e.g., a product name, an alphanumeric identifier assigned to the available installment loan by FI computing system 130, etc.), and may access structured or unstructured data records of a provisioning data store 408 maintained within the one or more tangible, non-transitory memories of FI computing system 130. In some instances, executed notification engine 152 may parse the structured or unstructured data records of provisioning data store 408 and identify one or more data records, such as data record 410, that includes or references product identifier 406 and as such, that is associated with the available installment loan. Data record 410 may include one or more elements of digital content 412 that, when rendered for presentation within a digital interface by client device 102, offers the pre-approved installment loan to user 101 in accordance with the terms and conditions, and prompts user 101 to accept, or alternatively, decline, the offer to fund the requested, and now-declined, $12,000.00 real-time payment to Sam's Roofing, and in some instances, the requested, real-time payments of $3,200.00 and $800.00 to respective ones of Lex's Home Improvement and Leo's Lawn Care, using the pre-approved installment loan based on, among other things, an approval, or alternatively, a rejection, of a nominal, real-time payment (e.g., in an amount of $1.00) requested from user 101 by the financial institution.

Executed notification engine 152 may obtain the one or more elements of digital content 412 from data record 410, and based on the one or more elements of digital content 412 and on the elements of account identifier 314 that identifies the deposit account selected by user 101 to fund the requested, and now-declined, $12,000.00 real-time payment, executed notification engine 152 may generate a nominal payment notification 414 that, when rendered for presentation within a corresponding digital interface by client device 102 in conjunction with product notification 402 (e.g., via display unit 109A of client device 102), prompts user 101 to accept the offered installment loan (e.g., in accordance with the determined terms and conditions) by providing input to client device 102 (e.g., via input unit 109B of client device 102) that approves the nominal, real-time payment (e.g., in the amount of $1.00, etc.) requested by the financial institution and funded by the selected deposit account. In some instances, executed notification engine 152 may package nominal payment notification 418 into a corresponding portion of product notification 402, e.g., in associated with selected product data 328. Executed notification engine 152 may also perform operations that package product notification 402, including the elements of confirmation data 318, the elements of selected product data 328, the elements of pending payment data 404, nominal payment notification 414, into a corresponding portion of notification data 416, and that cause FI computing system 130 to transmit notification data 416 across communications network 120 to client device 102.

A programmatic interface associated with one or more application programs executed at client device 102, such as an application programming interface (API) 420 associated with mobile banking application 108, may receive notification data 416 and may perform operations that cause client device 102 to executed mobile banking application 108 (e.g., through a generation of a programmatic command, etc.). Upon execution by the one or more processors of client device 102, executed mobile banking application 108 may receive notification data 416 from API 420, and a extraction module 422 of executed mobile banking application 108 may parse notification data 416 to obtain product notification 402, which includes the elements of confirmation data 318 (e.g., that characterizes the decision to decline the execution of the real-time payment of $12,000.00 associated with RFP message 202A), the elements of selected product data 328 (e.g., identifying the available installment loan and the determined terms and conditions), the elements of pending payment data 404 (that identify and characterize the additional, real-time payments of $3,200.00 and $800.00 requested by respective ones of Lex's Home Improvement and Leo's Lawn Care and capable of funding using the available installment loan), and nominal payment notification 414 (e.g., prompting user 101 to accept the offered installment loan by approving the real-time payment of the nominal amount from the selected payment instrument to the financial institution).

Extraction module 422 may provide product notification 402 as an input to an interface element generation module 424 of executed mobile banking application 108, which may perform operations that generate and route interface elements 426 to display unit 109A. When rendered for presentation within a corresponding notification interface 428 by display unit 109A, interface elements 426 provide a graphical representation of the now-declined, real-time payment of $12,000.00 requested by Sam's Roofing on Sep. 1, 2022, and the one-year, interest-free installment loan offered by the financial institution to fund the requested, and now-declined, payment to Sam's Roofing. In some instances, and when rendered for presentation within notification interface 428 by display unit 109A, interface elements 426 may also indicate an availability of the offered installment loan to fund one or more additional real-time payments requested from user 101, such as, but not limited to, the real-time payment of $3,200.00 requested from user 101 by Lex's Home Improvement on September 1^{st}, and the real-time payment of $800.00 requested from user 101 by Leo's Lawn Care, on September 1^{st} (e.g., as an alternative to funding these additional, real-time payments using the deposit account specified within the message fields of queued and pending RFP messages 202B and 202C, respectively). Further, when rendered for presentation within notification interface 428 by display unit 109A, interface elements 426 also prompt user 101 to accept, or decline, the offered installment loan in accordance with the determined terms and conditions by providing further input to client device 102 that approves, or rejects, the nominal, real-time payment requested by the financial institution, e.g., by providing input to input unit 109B that selects a respective one of an “APPROVE” icon 426A and a “REJECT” icon 426B presented within notification interface 428.

In some instances, user 101 may elect to accept the offered installment loan in accordance with the corresponding terms and conditions (e.g., the one-year term, the $5,500.00 loan amount, the zero-percent interest rate, and the monthly payment of $458.34, etc.) and to fund the now-declined, real-time payment of $12,000.00 requested by Sam's Roofing on September 1^{st}, and the additional real-time payments of $3,200.00 and $800.00 requested by respective ones of Lex's Home Improvement and Leo's Lawn Care on September 1^{st}, using funds provided by the installment loan. Referring to FIG. 4B, user 101 may provide input 429 to client device 102 (e.g., via input unit 109B) that selects “APPROVE” icon 426A, and as such, approves the real-time payment in the nominal amount (e.g., $1.00, etc.) requested by the financial institution and funded by the deposit selected by user 101 (e.g., as specified within RFP message 202A). Input unit 109B may receive input 429, and may route input data 430 indicative of the selection of “APPROVE” icon 426A by user 101, and the approval of the real-time payment requested by the financial institution, to a response module 432 of executed mobile banking application 108, which may perform operations that process input data 430 and generate one or more elements of data, e.g., confirmation data 434, that confirms the acceptance by user 101 of the offered installment loan in accordance with the corresponding terms and conditions (e.g., the one-year term, the $16,000.00 loan amount, the zero-percent interest rate, and the monthly payment of $1,333,34, etc.) and the approval by user 101 of the real-time payment in the nominal amount (e.g., $1.00, etc.) requested by the financial institution. Executed response module 432 may perform operations that cause client device 102 to transmit the elements of confirmation data 434 across communications network 120 to FI computing system 130.

A programmatic interface established and maintained by FI computing system 130, such as an application programming interface (API) 435 associated with executed notification engine 152, may receive the elements of confirmation data 434 and may route the elements of confirmation data 434 to executed notification engine 152, which may store the elements of confirmation data 434 within the one or more tangible, non-transitory memories of FI computing system 130, e.g., within a portion of data repository 134. Further, in some instances, executed notification engine 152 may also provide the elements of confirmation data 434 as input to a provisioning engine 436 that, when executed by the one or more processors of FI computing system 130, may perform operations that complete one or more internal qualification or underwriting processes (e.g., initiated by executed qualification module 326 of FIG. 3), and provision the offered installment loan to user 101 in accordance with the determined terms and conditions. For example, as illustrated in FIG. 4B, executed provisioning engine 436 may access the elements of selected product data 328 maintained within the one or more tangible, non-transitory memories of FI computing system 130 (e.g., within data repository 134), and may obtain, from the elements of selected product data 328, product identifier 406 associated with the offered, and now-accepted installment loan and condition data 438 that identifies and characterizes the terms and conditions of the now-accepted installment loan. As described herein the terms and conditions may include, but are not limited to, the one-year loan term, the $16,000.00 loan amount, the zero-percent interest rate, and the monthly payment of $1,333.34.

In some instances, executed provisioning engine 436 may perform operations that access the structured or unstructured data records of account data 140B associated with user 101 (e.g., that include or reference customer identifier 310 of user 101), and perform operations that generate an additional data record 440 associated with the installment loan provisioned to user 101. For example, data record 440 may include customer identifier 310 of user 101 and product identifier 406 of the provisioned installment loan. Further, and based on condition data 438, executed provisioning engine 436 may generate elements of product data 442 that identify the terms and conditions of the installment loan provisioned to user 101 (e.g., the one-year loan term, the $16,000.00 loan amount, the zero-percent interest rate, and the monthly payment of $1,333.34, etc.), and that include information characterizing a current amount of funds available via the provisioned installment loan (e.g., $16,000.00) and an outstanding monthly payment of $1,333.34 due on a corresponding due date. Executed provisioning engine 436 may perform operations that store the elements of product data 442 within a corresponding portion of data record 440, e.g., in associated with customer identifier 310 and product identifier 406. Further, although not illustrated in FIG. 4B, executed provisioning engine 436 may access one or more of the structured or unstructured data records of account data 140B associated with the deposit account selected by user 101 to fund the requested, and now-declined $12,000.00 real-time payment, and perform any of the exemplary processes described herein to debit the nominal amount of the real-time payment (e.g., $1.00, etc.) requested by the financial institution and approved by user 101, e.g., to indicate the acceptance of the installment loan by user 101.

Executed provisioning engine 436 may also generate one or more elements of data, e.g., provisioning confirmation data 444, that confirm the successful provisioning of the $16,000.00 installment loan to user 101 in accordance with the terms and conditions, and may route the generated elements of provisioning confirmation data 444 to a real-time payment (RTP) engine 446 that is executable by the one or more processors of FI computing system 130. In some instances, and upon execution by the one or more processors of FI computing system 130 (e.g., based on a programmatic signal generated by executed provisioning engine 436, etc.), executed RTP engine 446 may process the elements of provisioning confirmation data 444, and perform operations fund the declined, real-time payment of $12,000.00 requested by Sam′ Roofing on Sep. 1, 2022, using funds associated with the provisioned installment loan.

By way of example, executed RTP engine 446 may perform operations that access data record 440 of account data 140B, and perform operations that augment or modify portions of product data 442 to debit the $12,000.00 payment requested by Sam's Roofing for the provisioned roof-repair and roof-replacement services from the account associated with the provisioned installment loan. Executed RTP engine 446 may also perform operations that generate an additional real-time payment (RTP) message 448 that transfers the $12,000.00 in funds debited from the account associated with the provisioned installment loan to the financial services account associated with Sam's Roofing (e.g., the tokenized account number “XXX-9012-3456-7890,” as specified within message field 238 of RFP message 202A). As described herein, RTP message 448 may include discrete elements of message data characterizing the financial institution associated with FI computing system 130, Sam's Roofing, the transfer amount of $12,000.00, the account associated with the provisioned installment loan (e.g., that funds the transfer), and the financial services account of Sam's Roofing (e.g., that receives the proceeds of the transfer), and the elements of message data may populate one or more data fields structured or formatted in accordance with the ISO 20022 standard for electronic data exchange (e.g., as specified within field mapping data 138A, etc.).

Executed RTP engine 446 may also perform operations that cause FI computing system 130 to broadcast RTP message 448 directly across communications network 120 to one or more of intermediate computing systems associated with the RTP processing network, such as, but not limited to, the clearinghouse system associated with the RTP processing network, as described herein. In some instances, and prior to broadcasting RTP message 448 across communications network 120, executed RTP engine 446 may perform operations that encrypt RTP message 448 using a corresponding encryption key. Further, executed RTP engine 446 may also perform operations that access RFP message 202A maintained within RFP queue 135, and delete RFP message 202A from RFP queue 135, e.g., based on the provisioning of the installment loan to user 101 and on the funding of the $12,000.00 real-time payment requested by Sam's Roofing using funds from the provisioned installment loan.

Although not illustrated in FIG. 4B, the clearinghouse system may receive RTP message 448, and the clearinghouse system may, for example, parse RTP message 448 to access, within a corresponding one of the message fields, tokenized account data associated with the financial merchant account associated with Sam's Roofing, and based on the tokenized account data, the clearinghouse system may identify the financial institution of Sam's Roofing. The financial institution of Sam's Roofing may, for example, represent a participant in the RTP processing network, and the clearinghouse system may perform operations that obtain a network address associated with a computing system of the financial institution of Sam's Roofing (e.g., a “merchant FI computing system”), and the clearinghouse system may route RTP message 448 across communications network 120 to the merchant FI computing system based on the obtained network address.

The merchant FI computing system may receive RTP message 448, and based on the data populating the message fields of RTP message 448, the merchant FI computing system may perform operations that credit the account of Sam's Roofing with the $12,000.00 in real-time and contemporaneously with the initiation of the purchase of the roof-repair and roof-replacement services by user 101, and that route RTP message 448 across communications network 120 to merchant computing system 110, e.g., as a message confirming an execution of the requested, real-time payment using funds from the provisioned installment loan (not illustrated in FIG. 4B). Further, and as described herein, one or more portions of RTP message 448 may be encrypted (e.g., using an encryption key, as described herein), and the merchant FI computing system may perform operations that access a corresponding decryption key maintained within one or more tangible, non-transitory memories, and that decrypt the encrypted portions of RTP message 448 using the corresponding decryption key.

In some instances, described herein, confirmation data 434 may indicate an intention of user 101 to fund not only the requested, and now declined, real-time payment of $12,000.00, but also a real-time payment associated with one or more additional RFP messages pending within RFP queue 135 and awaiting processing, such as, but not limited to the real-time payment of $3,200.00 requested from user 101 by Lex's Home Improvement on September 1^{st} (e.g., associated with RFP message 202B within RFP queue 135) and the real-time payment of $800.00 requested from user 101 by Leo's Lawn Care, on September 1^{st} (e.g., (e.g., associated with RFP message 202C within RFP queue 135). Based on provisioning confirmation data 444, executed RTP engine 446 may access data record 440 of account data 140B, and perform operations that augment or modify portions of product data 442 to debit the $3,200.00 requested by Lex's Home Improvement for the provisioned window replacement services, and the $800.00 requested by Leo's Lawn Care for the provisioned landscaping services, from the account associated with the provisioned installment loan.

Executed RTP engine 446 may also perform operations that generate an additional RTP messages 450 and 452 that transfers, respectively, the $3,200.00 in funds debited from the account associated with the provisioned installment loan to the financial services account associated with Lex's Home Improvement (e.g., the tokenized account number specified within the message fields of RFP message 202B) and the $800.00 in funds debited from the account associated with the provisioned installment loan to the financial services account associated with Leo's Lawn Care (e.g., the tokenized account number specified within the message fields of RFP message 202C). As described herein, RTP message 450 may include discrete elements of message data characterizing the financial institution associated with FI computing system 130, Lex's Home Improvement, the transfer amount of $3,200.00, the account associated with the provisioned installment loan (e.g., that funds the transfer), and the financial services account of Lex's Home Improvement (e.g., that receives the proceeds of the transfer), and RTP message 452 may include discrete elements of message data characterizing the financial institution associated with FI computing system 130, Leo's Lawn Care, the transfer amount of $800.00, the account associated with the provisioned installment loan (e.g., that funds the transfer), and the financial services account of Leo's Lawn Care (e.g., that receives the proceeds of the transfer). Further, the elements of message data of RTP messages 450 and 452 may populate one or more data fields structured or formatted in accordance with the ISO 20022 standard for electronic data exchange (e.g., as specified within field mapping data 138A, etc.).

Executed RTP engine 446 may also perform operations that cause FI computing system 130 to broadcast RTP messages 450 and 452 directly across communications network 120 to one or more of intermediate computing systems associated with the RTP processing network, such as, but not limited to, the clearinghouse system associated with the RTP processing network, as described herein. In some instances, and prior to broadcasting RTP messages 450 and 452 across communications network 120, executed RTP engine 446 may perform operations that encrypt one or more of RTP messages 450 and 452 using a corresponding encryption key. Further, executed RTP engine 446 may also perform operations that access RFP messages 202B and 202C maintained within RFP queue 135, and delete RFP messages 202B and 202C from RFP queue 135.

In some instances, user 101 may elect to accept the offered installment loan in accordance with the determined terms and conditions, and may provide input to client device 102 (e.g., input 429 of FIG. 4B) that selects “Approve” icon 426A within notification interface 428, and that approves the corresponding, real-time payment in the nominal amount requested by the financial institution prior to provisioning the offered installment loan to user 101. In other instances, user 101 may elect to define the offered installment loan and may provide additional input to client device 102 (e.g., via input unit 109B) that selects the “REJECT” icon 426B presented within notification interface 428. Although not illustrated in FIG. 4A or 4B, input unit 109B may receive the additional input, and may route additional input indicative of the selection of “REJECT” icon 426B by user 101, and the rejection of the real-time payment requested by the financial institution, to executed response module 432 of executed mobile banking application 108, which may perform operations that process the additional input data and generate one or more additional elements of confirmation data that confirms the decision by user 101 to decline the offered installment loan in accordance with the corresponding terms and conditions (e.g., the one-year term, the $16,000.00 loan amount, the zero-percent interest rate, and the monthly payment of $1,333,34, etc.) and the rejection by user 101 of the real-time payment in the nominal amount (e.g., $1.00, etc.) requested by the financial institution. Executed response module 432 may perform operations that cause client device 102 to transmit the elements of additional elements of confirmation data across communications network 120 to FI computing system 130.

Although not illustrated in FIG. 4A or 4B, API 435 may receive the additional elements of confirmation data 434 and may route the additional elements of confirmation data to executed notification engine 152, which may store the additional elements of confirmation data within the one or more tangible, non-transitory memories of FI computing system 130, e.g., within a portion of data repository 134. In some instances, executed notification engine 152 may perform any of the exemplary processes described herein to generate an additional, ISO-20022-compliant message, such as an ISO-20022-compliant error message, that confirms the decision to decline the execution of the requested real-time payment, e.g., based on the determined inconsistencies between the execution of the real-time payment of $12,000.00 requested from user 101 by Sam's Roofing on Sep. 1, 2022, and one or more of the exemplary execution criteria described herein. Executed notification engine 152 may cause FI computing system 130 to broadcast the ISO-20022-compliant error message across network 120 to merchant computing system 110, either directly or through one or more of the intermediate systems described herein, such as the clearinghouse system or of the computing system of the financial institution of Sam's Roofing, and that delete RFP message 202A from RFP queue 135.

In some examples, described herein, executed analytical engine 148 may decline to execute the real-time payment of $12,000.00 requested from user 101 by Sam's Roofing on Sep. 1, 2022 (e.g., as associated with queued RFP message 202A) based on, among other things, a determined inconsistency between corresponding elements of decomposed field data and one or more of transaction-specific execution criteria 308A, account-specific execution criteria 308B, counterparty-specific execution criterion 308C, and behavior-specific execution criteria 308D. In other examples, consistency module 306 of executed analytical engine 148 may perform any of the exemplary processes described herein to establish a consistency between the elements of decomposed field data 204 (including the elements of customer data 206, payment data 208, transaction data 210, and counterparty data 212) and the discrete execution criteria associated with transaction-specific execution criteria 308A, account-specific execution criteria 308B, counterparty-specific execution criterion 308C, and behavior-specific execution criteria, and executed consistency module 306 may elect to approve the execution of the real-time payment of $12,000.00 requested from user 101 by Sam's Roofing on Sep. 1, 2022 (e.g., as associated with queued RFP message 202A).

Referring to FIG. 4C, executed consistency module 306 may perform operations that generate one or more elements of confirmation data 454 that characterize the approved execution of the real-time payment of $12,000.00 requested from user 101 by Sam's Roofing on Sep. 1, 2022, and may route the elements of confirmation data 454 to executed notification engine 152, which may receive the elements of confirmation data 454 and store the elements of confirmation data 454 within the one or more tangible, non-transitory memories of FI computing system 130, e.g., within a portion of data repository 134 (not illustrated in FIG. 4C). Executed notification engine 152 may perform operations that, based on customer identifier 310, access RTP data store 142 and obtain the elements of decomposed field data 204. As described herein, the elements of decomposed field data 204 may include one or more elements of customer data 206, payment data 208, transaction data 210, counterparty data 212, and remittance information 214 extracted from the structured or unstructured message fields of RFP message 202A and, as such, that identify and characterize the $12,000.00 payment requested from user 101 by Sam's Roofing on Sep. 1, 2022.

In some instances, and based on portions of decomposed field data 204, executed notification engine 152 may also perform operations that generate a payment notification 456 associated with the real-time payment of $12,000.00 requested from user 101 by Sam's Roofing on Sep. 1, 2022, and that package payment notification 456 into a corresponding portion of notification data 458. For example, executed notification engine 152 may parse payment data 208 to obtain payment information 460 that identifies the requested payment date of Sep. 1, 2022 (e.g., obtained from message field 228 of RFP message 202A) and the payment instrument selected by user 101 to fund the purchase transaction (e.g., the account number “XXXX-1234-5678-9012” obtained from message field 234 of RFP message 202A). Executed notification engine 152 may also parse transaction data 210 to obtain transaction information 462 that identifies the payment amount of the requested, $12,000.00 real-time payment and payment currency in US dollars (e.g., obtained from message fields 230 of RFP message 202A), and may parse counterparty data 212 to obtain merchant name 312 (e.g., a merchant name “Sam's Roofing” obtained from one or message fields 236 of RFP message 202A).

In some examples, executed notification engine 152 may perform operations that package all, or selected portion of, each of customer identifier 310, information 460 and 462, and merchant name 312 into corresponding portions of payment notification 456, which may be incorporated within notification data 458. Executed notification engine 152 may also perform operations that cause FI computing system 130 to transmit notification data 458, including payment notification 456, across communications network 120 to client device 102. As illustrated in FIG. 4C, a programmatic interface associated with one or more application programs executed at client device 102, such as API 420 associated with mobile banking application 108, may receive notification data 458 and may perform operations that cause client device 102 to execute mobile banking application 108 (e.g., through a generation of a programmatic command, etc.). Upon execution by the one or more processors of client device 102, executed mobile banking application 108 may receive notification data 458 from API 420, and executed extraction module 422 may parse notification data 458 and obtain payment notification 456.

Executed extraction module 422 may also provide payment notification 456 as an input to executed interface element generation module 424, which may perform operations that generate and route interface elements 464 to display unit 109A. In some instances, when rendered for presentation within notification interface 428 by display unit 109A, interface elements 464 may provide a graphical representation of payment notification 456 that prompts user 101 to approve or reject the $12,000.00 payment requested by Sam's Roofing on Sep. 1, 2022, for the purchased roof-repair and roof-replacement services, e.g., based on additional input provided to input unit 109B of client device 102 that selects a respective one of an “APPROVE” icon 464A and a “REJECT” icon 464A.

User 101 may, for example, elect to approve the $12,000.00 payment requested by Sam's Roofing, and user 101 may provide input to client device 102 (e.g., via input unit 109B) that selected “APPROVE” icon 464A. Based on the input, executed mobile banking application 108 may perform operations (not illustrated in FIG. 4C), that generate and transmit a response to notification data 458 that includes a payment confirmation indicative of the approved payment across communications network 120 to FI computing system 130, which may perform operations that, in real-time, debit the $12,000.00 from an account held by user 101 and associated with the selected payment instrument (e.g., the deposit account specified within message field 234 of RFP message 202A), and that credit the $12,000.00 to the financial services account associated with Sam's Roofing and specified within message field 238 of RFP message 202A (e.g., either directly, if the financial institution issues the financial services account associated with Sam's Roofing, or based on additional ISO-20022-compliant RTP messages exchanged with computing systems associated with other financial institution). FI computing system 130 may also perform operations that access RFP message 202A maintained within RFP queue 135, and delete RFP message 202A from RFP queue 135, e.g., based on the approval by user 101 and the real-time clearance and settlement of the approved payment.

Further, FI computing system 130 may also perform operations that transmit one or more messages to merchant computing system 110 that confirm the approval of the requested payment by user 101 and the real-time clearance and settlement of the approved payment, either directly across communications network 120 or through one or more of computing systems associated with participants in the RTP processing network (e.g., additional ISO-20022-compliant messages, etc.). Based on the one or more messages, merchant computing system 110 may perform operations that enable Sam's Roofing to execute the initiated purchase transaction.

In other instances, and based on confirmation data indicating a rejection by user 101 of the requested payment (e.g., based on additional input selecting “REJECT” icon 464B), FI computing system 130 may perform operations that delete RFP message 202A from RFP queue 135, and generate and transmit one or more messages to merchant computing system 110 indicative of the rejected payment, either directly across communications network 120 or through one or more of computing systems associated with participants in the RTP ecosystem (e.g., additional ISO-20022-compliant messages, etc.). Based on the indication of the rejection of the requested payment by user 101 (e.g., due to potential fraud, etc.), merchant computing system 110 may perform operations that enable Sam's Roofing to cancel the initiated purchase transaction in real-time and without delays and chargebacks characteristic of the transaction reconciliation, clearance, and settlement processes involving payment rails and transaction processing-messages.

In some instances, as described herein, FI computing system 130 may perform operations that decline to execute a requested, real-time payment associated with a pending RFP message, such as the real-time payment of $12,000.00 requested from user 101 by Sam's Roofing and associated with RFP message 202A, based on a determined inconsistency between the elements of decomposed field data 204 and one or more execution criteria, such as, but not limited to, one or more of one or more of transaction-specific execution criteria 308A, account-specific execution criteria 308B, counterparty-specific execution criterion 308C, and behavior-specific execution criteria 308D. Through a performance of one or more of the exemplary processes described herein, FI computing system 130 may perform operations that “convert” the now-declined real-time payment requested by Sam's Roofing into a corresponding, targeted financing offer associated with the pre-approved loan product, which may be provisioned to user 101 via client device 102 in real-time and contemporaneously with the initiation of the corresponding purchase transaction or interception of the RFP message.

The disclosed embodiments are, however, not limited to processes that convert declined real-time payments into corresponding targeted financial offers, and in other instances, FI computing system 130 may monitor continuously the spending or purchasing habits of user 101, may identify a loan product, such as an installment loan, that would be available to user 101 and consistent with the monitored spending or purchasing habits, and may perform any of the exemplary processes described herein to provision the available loan product to user 101 in real-time using ISO-20022-compliant messaging protocols. By way of example, executed analytical engine 148 may perform operations, described herein, to access elements of profile data 140A, account data 140B, transaction data 140C, and reporting or credit bureau data of third-party data 140D that are associated with user 101 (e.g., that include, or reference, customer identifier 310).

Based on the accessed elements of elements of profile data 140A, account data 140B, transaction data 140C, and reporting or credit bureau data, on the elements of decomposed field data 204, 248, and 260, and additionally, or alternatively, one or more elements of aggregated data characterizing user 101 and user 101's interaction with the financial institution of with other financial institutions during prior temporal intervals (e.g., a transaction velocity associated with one or more payment instruments, aggregated amounts of spending over the one or more prior temporal intervals, etc.) executed analytical engine 148 may perform operations that generate one or more elements of behavioral data that identify and characterize the spending and purchasing habits of user 101, and the user 101's interaction with the financial institution, over one or more temporal intervals. By way of example, the elements of behavioral data may characterize an expected total amount of customer spending during a future, one-month interval, and additionally, or alternatively, may characterize an expected amount of spending funded by a particular payment instrument, during the future, one-month interval.

By way of example, executed analytical engine 148 may perform operations that apply a trained machine learning or artificial intelligence process to an input dataset obtained, or extracted from, subsets of the elements of profile data 140A, account data 140B, transaction data 140C, and reporting or credit bureau data associated with user 101, the elements of decomposed field data 204, 248, and 260, and the elements of aggregated data (e.g., the transaction velocities, the aggregated spend, etc.). Based on the application of the trained machine learning or artificial intelligence process to the input dataset, executed analytical engine 148 may generate the one or more of the elements of behavioral data that behavioral data that identify and characterize the spending and purchasing habits of user 101, and the interactions of user 101 with the financial institution, during the future, one-month temporal interval.

Examples of the trained machine-learning and artificial-intelligence processes may include, but are not limited to, a clustering process, an unsupervised learning process (e.g., a k-means algorithm, a mixture model, a hierarchical clustering algorithm, etc.), a semi-supervised learning process, a supervised learning process, or a statistical process (e.g., a multinomial logistic regression model, etc.). The trained machine-learning and artificial-intelligence processes may also include, among other things, a decision tree process (e.g., a boosted decision tree algorithm, etc.), a random decision forest, an artificial neural network, a deep neural network, or an association-rule process (e.g., an Apriori algorithm, an Eclat algorithm, or an FP-growth algorithm). Further, and as described herein, each of these exemplary machine-learning and artificial-intelligence processes may be trained against, and adaptively improved using, elements of training and validation data, and may be deemed successfully trained and ready for deployment when a value of one or more performance or accuracy metrics are consistent with one or more threshold training or validation criteria.

For instance, the trained machine learning or artificial intelligence process may include a trained decision-tree process, and executed analytical engine 148 may obtain, from one or more tangible, non-transitory memories of FI computing system 130, elements of process input data and process parameter data associated with the trained decision-tree process. For example, the elements of process input data may characterize a composition of the input dataset for the trained decision-tree process and identify each of the discrete data elements within the input data set, along with a sequence or position of these elements within the input data set, and the elements of process parameter data may include a value for one or more parameters of the trained decision-tree process. Examples of these parameter values include, but are not limited to, a learning rate associated with the trained, decision-tree process, a number of discrete decision trees included within the trained, decision-tree process, a tree depth characterizing a depth of each of the discrete decision trees, a minimum number of observations in terminal nodes of the decision trees, and/or values of one or more hyperparameters that reduce potential process overfitting.

In some examples, executed analytical engine 148 may perform operations that generate one or more discrete elements (e.g., “feature values”) of the input dataset in accordance with the elements of process input data and based on the elements of profile data 140A, account data 140B, transaction data 140C, and reporting or credit bureau data associated with user 101, the elements of decomposed field data 204, 248, and 260, and the elements of aggregated data. Based on portions of the process parameter data, executed intent determination module 306 may perform operations that establish a plurality of nodes and a plurality of decision trees for the trained decision-tree process, each of which receive, as inputs (e.g., “ingest”), corresponding elements of the input dataset. Further, and the ingestion of the input dataset by the established nodes and decision trees of the trained decision-tree process, executed analytical engine 148 may perform operations that apply the trained, decision-tree process to the input dataset, and that generate the one or more of the elements of behavioral data that characterize, among other things, a total amount of spending on purchase transactions involving payment instruments issued by the financial institution during the future, one-month temporal interval.

Executed analytical engine 148 may, in some instances, provision the elements of behavioral data as an input to executed conversion engine 150, which may perform any of the exemplary processes described herein to pre-approve user 101 for a loan product available to, and appropriate to, fund the expected total amount of spending on purchase transactions by user 101 future, one-month temporal interval. By way of example, executed conversion engine 150 may perform any of the exemplary processes described herein, either individually or in conjunction with executed notification engine 152, to generate elements of notification data that include an identifier of the available loan product and data characterizing one or more determined terms and conditions of the available loan product (the selected product data described herein) and a nominal payment notification that, when presented to user 101 within a corresponding digital interface of device 102 (e.g., notification interface 428), prompts user 101 indicate an acceptance of the available loan product in accordance with the determined terms and conditions by approving a real-time payment requested by the financial institution in a nominal amount (e.g., $1.00, etc.). In some instances, FI computing system 130 may transmit, or push, the generated elements of notification data across network 120 to client device 102, which may perform any of the exemplary processes described herein to render the elements of notification data for presentation to user 101 within the corresponding digital interface.

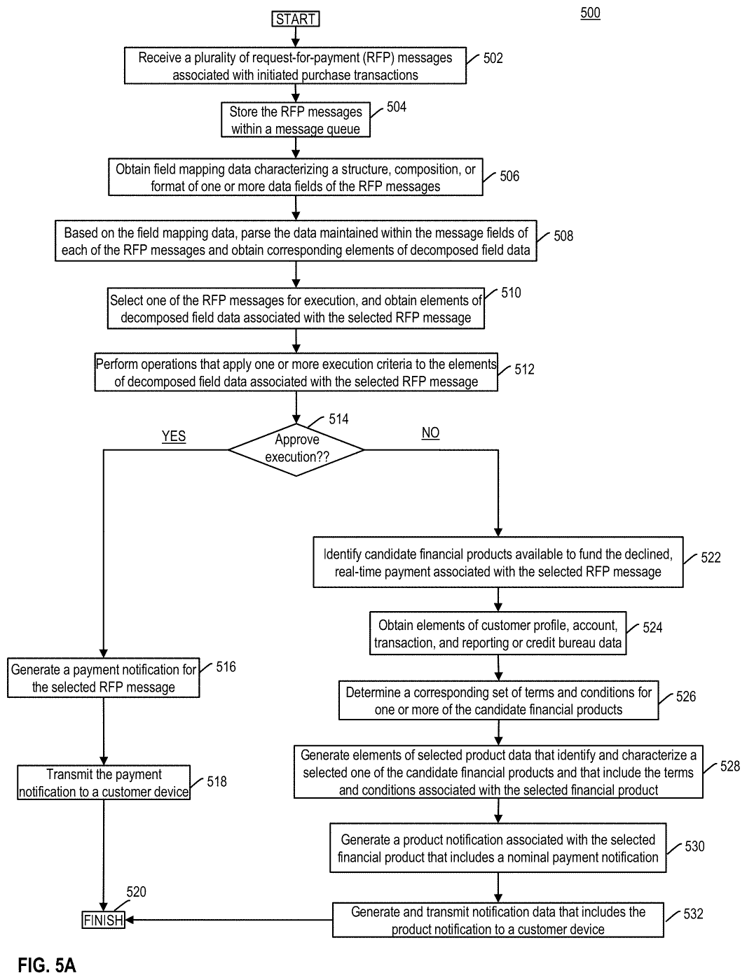

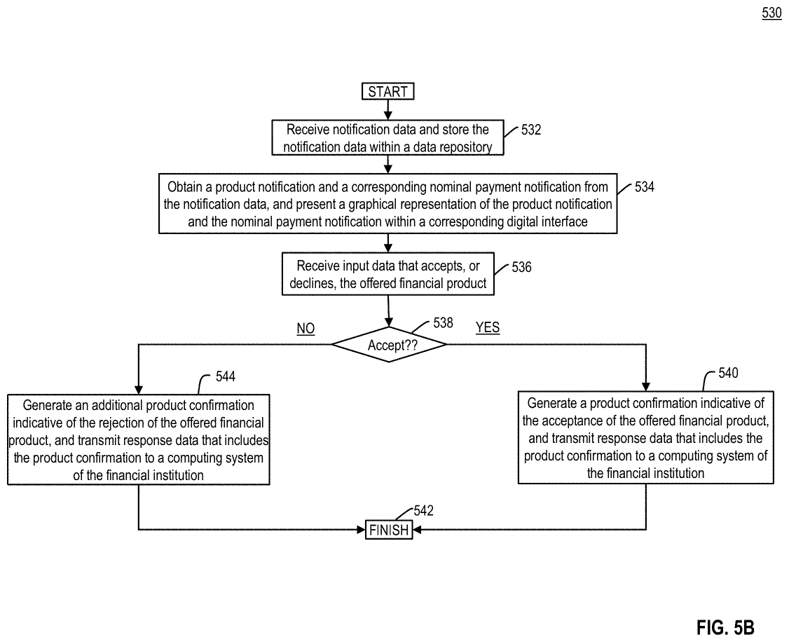

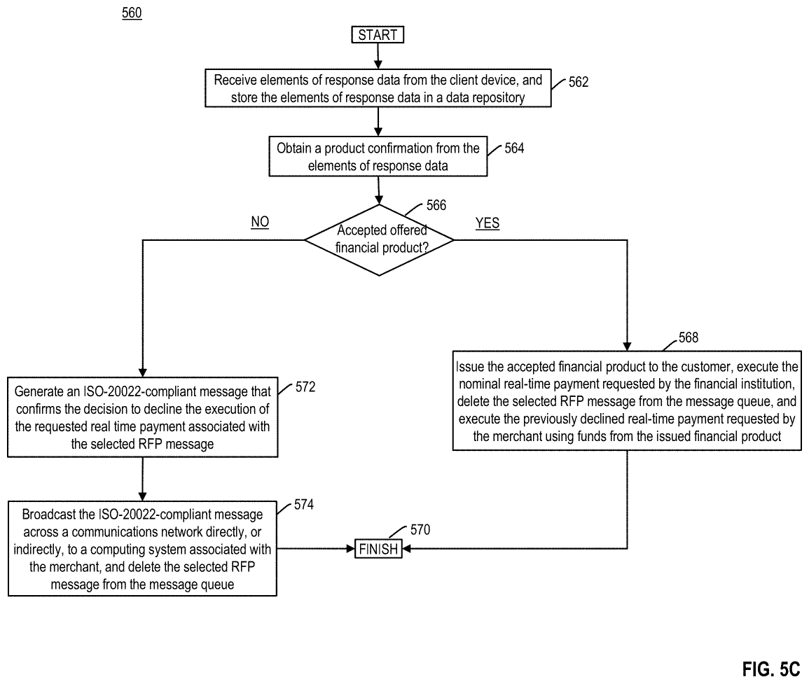

FIGS. 5A, 5B, and 5C are flowcharts of exemplary processes for provisioning, in real-time, targeted product data associated with initiated data exchanges to customer devices based on structured messaging data, in accordance with some exemplary embodiments. For example, one or more computing systems associated with a financial institution, such as FI computing system 130, may perform one or more of the steps of exemplary process 500, as described below in reference to FIG. 5A, and one or more of the steps of exemplary process 560, as described below in reference to FIG. 5C. Further, a computing device associated with, or operable by, user 101, such as client device 102, may perform one or more of the steps of exemplary process 530, as described below in reference to FIG. 5B.

Referring to FIG. 5A, FI computing system 130 may perform any of the exemplary processes described herein to receive a plurality of request-for-payment (RFP) messages having message fields structured in accordance with the ISO 20022 standard (e.g., in step 502 of FIG. 4A), and to store the received RFP message within a message queue (e.g., in step 504 of FIG. 4A). As described herein, each of the RFP messages (e.g., one or more of RFP messages 202A, 202B, and 202C) may be associated with a corresponding exchange of data, such as a purchase transaction, initiated between a first counterparty (e.g., a customer of the financial institution, such as user 101) and a corresponding second counterparty (e.g., a merchant associated with one of merchant systems 110, 114, and 118), and the message fields of each of the RFP messages may include data that identifies and characterizes a real-time payment requested from the first counterparty by the corresponding second counterparty (e.g., to fund a corresponding one of the initiated purchase transactions). Further, as described herein, each of the RFP messages may be structured in accordance with the ISO 20022 standard for electronic data exchange between financial institutions, and in some examples, each of the RFP messages may correspond to a pain.013 message as specified within the ISO 20022 standard.

FI computing system 130 may also perform operations, described herein, to access mapping data that identifies and characterizes each of the messages fields within the ISO-20022-compliant RFP messages (e.g., in step 506 of FIG. 4A). Based on the mapping data, FI computing system 130 may perform any of the exemplary processes described herein to parse and analyze all or a selected subset of the message fields of each of the RFP messages to extract, obtain, or derive corresponding, discrete elements of decomposed field data that identify and characterize the first counterparty (e.g., user 101), the corresponding second counterparty (e.g., one of the merchants associated with merchant systems 110, 114, or 118), the initiated purchase transaction, and the requested, real-time payment (e.g., in step 508 of FIG. 5A). FI computing system 130 may perform additional operations, described herein, that store the extracted, obtained, or derived data elements of decomposed field data associated with each of the RFP messages, within an accessible data repository (e.g., within an element of RTP data store 142 of FIG. 1).

In other instances, also in step 508, FI computing system 130 may perform any of the exemplary processes described herein to detect, within one or more of the message fields of a corresponding one of the RFP messages, a link to the remittance data associated with the requested, real-time payment or the corresponding initiated purchase (e.g., a link to a PDF or HTML invoice or receipt associated with the corresponding initiated purchase transaction). By way of example, the link may correspond to a long-form uniform resource locator (URL) into which certain elements of data may be embedded, such as, but not limited to, a unique identifier of the customer, and FI computing system 130 may perform operations, described herein, that parse the long URL to identify and extract the embedded data, which FI computing system 130 may store within one or more of the discrete elements of decomposed field data associated with the corresponding one of the RFP messages.

Additionally, or alternatively, in step 508, FI computing system 130 may perform any of the exemplary processes described herein that, based on the detected link (e.g., the long-form URL described above, or a shortened URL, such as a tiny URL), programmatically access the remittance data associated with the processed link (e.g., as maintained at a corresponding one of merchant systems 110, 114, or 118). The remittance data may include a PDF or HTML invoice or bill (e.g., formatted invoice data 218 of FIG. 2A), and the FI computing system 130 may perform operations that process the remittance data (e.g., through an application of an optical character recognition (OCR) process to the PDF invoice or bill, parsing code associated with the HTML invoice or bill, applying a screen-scraping technology to the invoice or bill, etc.) to extract the additional, or alternate, elements of the data that identifies and characterizes user 101, the second counterparty, the initiated purchase transaction, and the requested, real-time payment. As described herein, FI computing system 130 may store the additional, or alternate, elements of the data that identifies and characterizes user 101, the second counterparty, the initiated purchase transaction, and the requested, real-time payment within one or more of the discrete elements of decomposed field data associated with the corresponding one of the RFP messages.

In some instances, FI computing system 130 may perform any of the exemplary processes described herein to select one of the pending RFP messages storied within the message queue, such as RFP message 202A, and obtain one or more of the elements of decomposed field data associated with the selected RFP message, such as the elements of decomposed field data 204 (e.g., in step 510 of FIG. 5). FI computing system 130 may also perform any of the exemplary processes described herein to obtain data characterizing one or more execution criteria associated with the selected RFP message, and to apply each of the one or more execution criteria to the elements of decomposed field data associated with the selected RFP message (e.g., in step 512 of FIG. 5).

Based on the application of the one or more execution criteria (e.g., the transaction-specific execution criterion, account-specific execution criterion, counterparty-specific execution criterion, or behavior-specific execution criterion, etc.) to the elements of decomposed field data or associated with the selected RFP message or to corresponding elements derived behavioral data, FI computing system 130 may perform any of the exemplary processes described herein to determine to approve, or alternatively, decline, the execution of the requested, real-time payment associated with the selected RFP message (e.g., in step 514 of FIG. 5). By way of example, in step 514 of FIG. 5, FI computing system 130 may perform operations, described herein to approve the execution of the requested, real-time payment associated with the selected RFP message based on a determined consistency between each of the one or more execution criteria and the corresponding elements of the elements of decomposed field data or behavioral data, or alternatively, to decline the execution of the requested, real-time payment associated with the selected RFP message based on a determined inconsistency between at least one of the execution criteria and the corresponding elements of the elements of decomposed field data or behavioral data.

If, for example, FI computing system 130 were to approve the execution of the requested, real-time payment associated with the selected RFP message (e.g., step 514; YES), FI computing system 130 may perform any of the exemplary processes described herein to generate one or more elements of a payment notification associated with the requested, real-time payment associated with the selected RFP message based on all, or a selected portion, of the decomposed field data (e.g., in step 516 of FIG. 5A). By way of example, and as described herein, the payment notification may include, among other things, the full name of user 101, the requested payment amount and payment date, information identifying a customer account that funds the requested payment, and information identifying the corresponding merchant. Further, the payment notification may also include digital content that, when presented on a digital interface generated by an application program executed at client device 102 (e.g., mobile banking application 108 of FIG. 1, etc.), prompt user 101 to provide input to client device 102 that approves, or alternatively, rejects, the requested, real-time payment.

FI computing system 130 may perform any of the exemplary processes described herein to transmit the generated payment notification across communications network 120 to client device 102 (e.g., in step 518 of FIG. 5A). In some instances, client device 102 may receive the elements of notification data, and an application program executed by the one or more processors of client device 102 (e.g., executed mobile banking application 108) may perform any of the exemplary processes described herein to present, within a corresponding digital interface, a graphical representation of the payment notification that prompts user 101 to approve, or alternatively, reject, the requested, real-time payment associated with the selected RFP message using the selected financial product based on a provision of input to client device 102 (e.g., via input unit 109B of client device 102). Exemplary process 500 may be complete in step 520.

Referring back to step 514, if FI computing system 130 were to decline to execute the requested, real-time payment associated with the selected RFP message (e.g., step 514; YES), FI computing system 130 may perform any of the exemplary processes described herein to identify one or more candidate financial products that are appropriate to fund the requested, and declined, real-time payment associated with the selected RFP message (e.g., in step 522 of FIG. 5A). By way of example, in step 522, FI computing system 130 may perform operations, described herein, that obtain elements of candidate financial product data identifying and characterizing each of the candidate financial products, and specifying one or more internal qualification or underwriting criteria associated with each of the candidate financial products to user 101. FI computing system 130 may also perform operations, described herein, that access one or more elements of customer profile data, account data, and transaction data associated with user 101, and further, that obtain one or more elements of additional data that characterize user 101, one or more financial services accounts held by user 101, or the interactions between user 101 and the financial institution, such as, but not limited to, elements of reporting or credit-bureau data (e.g., in step 524 of FIG. 5A).

Based on the elements of candidate financial product data, FI computing system 130 may perform any of the exemplary processes described herein to apply the internal qualification or underwriting criteria associated with corresponding ones of the identified candidate financial products to the elements of customer profile data, account data, transaction data, and additional data (e.g., the reporting or credit-bureau data) associated with user 101, and to determine a set candidate terms and conditions for each of the identified candidate financial products (e.g., in step 526 of FIG. 5A). As described herein, the determination of a set of terms and conditions for a corresponding one of the identified candidate financial products may, in some instances, “pre-approve” user 101 for a subsequent issuance or provisioning of that candidate financial products Further, and based on the candidate terms and conditions, FI computing system 130 may perform any of the exemplary processes described herein to select one of the identified candidate financial products (e.g., as a targeted financial offer for the requested, real-time payment), and to package portions of the candidate financial product data that identify and characterize the selected financial product, and information identifying the term and conditions associated with the selected financial product, into corresponding portions of selected product data (e.g., in step 528 of FIG. 5A).

By way of example, the candidate financial product data may identify, and characterize, a loan product, such as an installment loan, that is available for provisioning to user 101 and that is appropriate to fund the requested, and now-declined, real-time payment associated with the selected RFP message. In some instances, based on an application of the internal qualification or underwriting criteria associated with the installment loan to the elements of profile data, account data, transaction data, and reporting or credit-bureau data associated with user 101, FI computing system 130 may perform any of the exemplary processes described herein to “pre-approve” user 101 for the installment loan based on determined terms and conditions that include, but are not limited to, a term of one year, a corresponding loan amount, a zero-percent interest rate, and a corresponding monthly payment during each month of the one-year term. Further, FI computing system 130 may also perform any of the exemplary processes described herein to select the pre-approved installment loan as the targeted financing offer for the now-declined, real-time payment associated with the selected RFP message, and to package, into corresponding portions of the selected product data, portions of the candidate financial product data that identify and characterize the selected installment loan, and information identifying the determined term and conditions associated with the selected installment loan.

Referring back to FIG. 5A, FI computing system 130 may also perform any of the exemplary processes described herein to generate a product notification associated with the selected financial product, such as, but not limited to, the one-year, interest-free installment loan pre-approved for provisioning to user 101 (e.g., in step 530 of FIG. 5A). For example, the generated product notification may include portions of the selected product data that identify and characterize the selected financial product (e.g., the one-year, interest-free installment loan) and further, that specify the determined terms and conditions of that selected financial product (e.g., the one-year term, the zero-percent interest rate, the corresponding loan amount, and the corresponding monthly payment, etc.). The generated product notification may also include a nominal payment notification that, when presented on a digital interface generated by an application program executed at client device 102 (e.g., mobile banking application 108 of FIG. 1, etc.), prompt user 101 to accept, or alternatively, decline, an offer to fund the requested, real-time payment using the selected financial product (e.g., the one-year, interest-free installment loan) in accordance with the determined terms and conditions by providing, to client device 102, input that approves a nominal, real-time payment requested by the financial institution, such as, but not limited to, e.g., a $1.00 real-time payment.

FI computing system 130 may perform any of the exemplary processes described herein to package the generated product notification (including the selected product data and the nominal payment notification) into corresponding portions of notification data, and to transmit the notification data across communications network 120 to client device 102 (e.g., in step 532 of FIG. 5A). In some instances, client device 102 may receive the elements of notification data, and an application program executed by the one or more processors of client device 102 (e.g., executed mobile banking application 108) may perform any of the exemplary processes described herein to present, within a corresponding digital interface, a graphical representation of the product notification that prompts user 101 to accept, or alternatively, decline, the offer to fund the requested, real-time payment using the selected financial product, based on a provision of input to client device 102 (e.g., via input unit 109B of client device 102) that approves the real-time payment of the nominal amount. Exemplary process 500 may be complete in step 520.

Referring to FIG. 5B, client device 102 may perform any of the exemplary processes described herein to receive the elements of notification data from FI computing system 130, and store the elements of notification data within a portion of a tangible, non-transitory memory accessible to client device 102 (e.g., in step 532 of FIG. 5B). Client device 102 may also perform any of the exemplary processes described herein to obtain the product notification (e.g., including the selected product data and the nominal payment notification) from the received elements of notification data, and generate, and render for presentation within a corresponding digital interface, a graphical representation of portions of the product notification that prompts user 101 to accept, or alternatively, decline, the offer to fund the requested, and now-declined, real-time payment using the selected financial product based on a provision of additional input to client device that approves the nominal, real-time payment requested by the financial institution (e.g., in step 534 of FIG. 5B). Further, client device 102 may also receive, via input unit 109B, elements of user input that accepts, or alternatively, declines, the offer to fund the real-time payment requested by the corresponding merchant using the selected financial product (e.g., in step 536 of FIG. 5B).

As described herein, the user input received via input unit 109B by may indicate an approval, or alternatively, a rejection, by user 101 of the nominal real-time payment requested by the financial institution, and based on the elements of user input, client device 102 may determine whether user 101 approved, or rejected, the nominal real-time payment requested by the financial institution and as such, whether user 101 accepted, or rejected, the offer to fund the requested, and now-declined real-time payment using the selected financial product (e.g., in step 538 of FIG. 5B). If, for example, client device 102 were to determine that user 101 approved the nominal real-time payment requested by the financial institution and as such, that user 101 accepted the offer to fund the requested, and now-declined, real-time payment 1 using the selected financial product (e.g., step 538; YES), client device 102 may perform any of the exemplary processes described herein to process the elements of input data and generate a product confirmation indicative of the approval, by user 101, of the nominal real-time payment requested by the financial institution and the acceptance, by user 101, of the offer to fund the requested, and now-declined, real-time payment using the selected financial product (e.g., in step 540 of FIG. 5B). Client device 102 may also perform operations that transmit a response to the notification data that includes the product confirmation to FI computing system 130 (e.g., also in step 540 of FIG. 5B). Exemplary process 530 may be complete in step 542.

Alternatively, if client device 102 were to determine that user 101 rejected the nominal real-time payment requested by the financial institution and as such, that user 101 rejected the offer to fund the requested, and declined, real-time payment using the selected financial product (e.g., step 538; NO), client device 102 may perform any of the exemplary processes described herein to generate an additional product confirmation indicating the rejection of both the nominal real-time payment requested by the financial institution and the offer to fund the declined real-time payment using the selected financial product (e.g., in step 544 of FIG. 5B). Client device 102 may also perform operations that transmit a response to the notification data that includes the additional product confirmation to FI computing system 130 (e.g., also in step 544 of FIG. 5B). Exemplary process 530 may be complete in step 542.

Referring to FIG. 5C, FI computing system 130 may receive the elements of response data from client device 102, and may store the received elements of response data within one or more tangible, non-transitory memories accessible to FI computing system 130, such as in conjunction with the elements of decomposed field data within data repository 134 (e.g., in step 562 of FIG. 5C). FI computing system 130 may also perform any of the exemplary processes described herein to obtain, from the elements of response data, a product confirmation indicative of the acceptance, or alternatively, the rejection, of the nominal real-time payment requested by the financial institution and as such, the acceptance, or alternatively, the rejection, of the offer to fund the declined, real-time payment using the selected financial product (e.g., in step 564 of FIG. 5C), and to process the product confirmation and determine whether user 101 accepted, or declined, the offer (e.g., in step 566 of FIG. 4C).

If, for example, FI computing system 130 were to determine that user 101 accepted the offer to fund the declined, real-time payment using the selected financial product based on the approval of the nominal, real-time payment requested by the financial institution (e.g., step 566; YES), FI computing system 130 may perform any of the exemplary processes described herein to complete a qualification or underwriting process and to provision the selected financial product to the customer (e.g., in step 568 of FIG. 5C). FI computing system 130 may also perform any of the exemplary processes described herein, in step 568, to execute the previously declined real-time payment using funds drawn from the now-issued financial product, and to delete the RFP message from the message queue. FI computing system 130 may perform any of the exemplary processes described herein, in step 568, to execute the nominal, real-time payment requested by the financial institution (e.g., the nominal, $1.00 payment, etc.). Exemplary process 560 may then be complete in step 570.

Alternatively, if FI computing system 130 were to determine that user 101 declined the offer to fund the declined real-time payment using the selected financial product based on the rejection of the nominal, real-time payment requested by the financial institution (e.g., step 566; NO), FI computing system 130 may perform any of the exemplary processes described herein to generate an additional, ISO-20022-compliant message, such as an ISO-20022-compliant error message, that confirms the decision by FI computing system 130 to decline the execution of the requested real-time payment associated with the selected RFP message (e.g., in step 572 of FIG. 5C). For example, FI computing system 130 may decline to execution the requested real-time payment based on a determined inconsistency between the execution of the real-time payment (e.g., in accordance with corresponding elements of decomposed field data associated with the selected RFP message) and one or more of the one or more execution criteria described herein, such as, but not limited to, one or more of the transaction-, account-specific, counterparty, or behavior-specific execution criteria. FI computing system 130 may also perform operations that broadcast the ISO-20022-compliant error message across network 120 to merchant computing system 110, either directly or through one or more of the intermediate systems described herein, such as the clearinghouse system or of the computing system of the financial institution of the merchant, and that delete the selected RFP message from the RFP queue (e.g., in step 574 of FIG. 5C). Exemplary process 560 may then be complete in step 570.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including merchant application 106, mobile banking application 108, decomposition engine 146, analytical engine 148, conversion engine 150, notification engine 152, application programming interfaces (APIs) 203, 420, and 435, remittance analysis engine 242, selection module 302, consistency module 306, product determination module 322, qualification module 326, offer generation module 330, extraction module 422, interface element generation module 424, response module 432, provisioning engine 436, real-time payment (RTP) engine 446, may be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user 101, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

What is claimed is:

1. An apparatus comprising:
a communications interface;
a memory storing instructions; and
at least one processor coupled to the communications interface and to the memory, the at least one processor being configured to execute the instructions to:
receive, via the communications interface, a message associated with a first real-time payment requested from a first counterparty by a second counterparty, the message comprising elements of message data disposed within corresponding message fields, and the message data characterizing an exchange of data initiated between the first and second counterparties;
determine a value of a first parameter of the initiated data exchange based on the elements of message data, and determine that the first parameter value is inconsistent with an execution criterion; and
based on the determined inconsistency, generate product data characterizing a product available to the first counterparty, and transmit, via the communications interface, notification data to a first device operable by the first counterparty, the notification data comprising digital content associated with the available product and with the data exchange, and the first device being configured to present at least a portion of the digital content within a digital interface.

2. The apparatus of claim 1, wherein the at least one processor is further configured to execute the instructions to, based on response data generated by the first device, perform operations that provision the available product to the first counterparty in accordance with the product data.

3. The apparatus of claim 1, wherein:
the product data comprises a product identifier and a second parameter value of the available product, and the notification data is associated with an offer to provision the available product to the first counterparty in accordance with the second parameter value; and
the at least one processor is further configured to execute the instructions to:
receive response data from the first device via the communications interface;
establish that the response data is associated with an acceptance of the offer to provision the available product to the first counterparty in accordance with the second parameter value; and
perform operations that provision the available product to the first counterparty in accordance with the second parameter value.

4. The apparatus of claim 3, wherein:
the first notification data comprises additional digital content associated with a second real-time payment;
the first device is further configured to present at least a portion of the additional digital content within the digital interface; and
the at least one processor is further configured to execute the instructions to:
determine that the response data is associated with an approval of the second real-time payment; and
establish that the response data is associated with the acceptance of the offer based on the determination that the response data is associated with the approval of the second real-time payment.

5. The apparatus of claim 1, wherein:
the product data comprises a product identifier and a second parameter value of the available product; and
the at least one processor is further configured to execute the instructions to:
obtain a qualification criterion associated with the product from the memory; and
determine the second parameter value based on the qualification criterion and on one or more of the elements of message data.

6. The apparatus of claim 1, wherein:
the first parameter value comprises a value of a behavioral parameter; and
the at least one processor is further configured to execute the instructions to:
obtain additional elements of message data from the memory, the additional elements of message data characterizing an additional exchange of data involving the first counterparty during a prior temporal interval; and
determine the behavioral parameter value based on a portion of the elements of message data and the elements of additional message data.

7. The apparatus of claim 1, wherein the at least one processor is further configured to execute the instructions to:
obtain, from the memory, data characterizing a plurality of execution criteria; and
based on an application of each of the plurality of execution criterion to the first parameter value, determine that the first parameter value is inconsistent with at least a subset of the execution criteria.

8. The apparatus of claim 1, wherein the at least one processor is further configured to execute the instructions to perform operations that decline to execute the first real-time payment in accordance with the first parameter value based on the determination that the first parameter value is inconsistent with the execution criteria.

9. The apparatus of claim 8, wherein the at least one processor is further configured to execute the instructions to, based on the provisioning of the product to the first counterparty, perform operations that execute the first real-time payment in accordance with the product data.

10. The apparatus of claim 1, wherein the at least one processor is further configured to execute the instructions to:
obtain, from the memory, mapping data associated with the message fields of the message;
perform operations that obtain the elements of message data from the message fields based on the mapping data; and
store the elements of message data within the memory, the elements of message data comprising a first identifier of the first counterparty, a second identifier of the second counterparty, and the first parameter value.

11. The apparatus of claim 10, wherein:
the message comprises a request-for-payment message, the message fields of the request-for-payment message being structured in accordance with a standardized data-exchange protocol; and
elements of the mapping data identify corresponding ones of the elements of message data and corresponding ones of the message fields.

12. The apparatus of claim 10, wherein the at least one processor is further configured to execute the instructions to:
obtain, based on the mapping data, remittance information associated with the data exchange from one or more of the message fields, the remittance information comprising a uniform resource locator associated with elements of formatted data maintained by a computing system associated with the second counterparty;
process the elements of formatted data; and
obtain at least one of the first identifier, the second identifier, or the first parameter value characterizing the data exchange from the processed elements of formatted data.

13. A computer-implemented method, comprising:
receiving, using at least one processor, a message associated with a first real-time payment requested from a first counterparty by a second counterparty, the message comprising elements of message data disposed within corresponding message fields, and the message data characterizing an exchange of data initiated between the first and second counterparties;
using the at least one processor, determining a value of a first parameter of the initiated data exchange based on the elements of message data, and determining that the first parameter value is inconsistent with an execution criterion; and
based on the determined inconsistency, generating, using the at least one processor, product data characterizing a product available to the first counterparty, and transmitting, using the at least one processor, notification data to a first device operable by the first counterparty, the notification data comprising digital content associated with the available product and with the data exchange, and the first device being configured to present at least a portion of the digital content within a digital interface.

14. The computer-implemented method of claim 13, wherein:
the product data comprises a product identifier and a second parameter value of the available product, and the notification data is associated with an offer to provision the available product to the first counterparty in accordance with the second parameter value; and
the computer-implemented method further comprises:
receiving response data from the first device using the at least one processor;
establishing, using the at least one processor, that the response data is associated with an acceptance of the offer to provision the available product to the first counterparty in accordance with the second parameter value; and
performing operations, using the at least one processor, that provision the available product to the first counterparty in accordance with the second parameter value.

15. The computer-implemented method of claim 14, wherein:
the first notification data comprises additional digital content associated with a second real-time payment;
the first device is further configured to present at least a portion of the additional digital content within the digital interface;
the computer-implemented method further comprises determining, using the at least one processor, that the response data is associated with an approval of the second real-time payment; and
the establishing comprises establishing that the response data is associated with the acceptance of the offer based on the determination that the response data is associated with the approval of the second real-time payment.

16. The computer-implemented method of claim 13, wherein:
the product data comprises a product identifier and a second parameter value of the available product; and
the computer-implemented method further comprises:
obtaining, using the at least one processor, a qualification criterion associated with the product from a data repository; and
determining, using the at least one processor, the second parameter value based on the qualification criterion and on one or more of the elements of message data.

17. The computer-implemented method of claim 13, wherein:
the first parameter value comprises a value of a behavioral parameter; and
the computer-implemented method further comprises:
obtaining, using the at least one processor, additional elements of message data from a data repository, the additional elements of message data characterizing an additional exchange of data involving the first counterparty during a prior temporal interval; and
determining, using the at least one processor, the behavioral parameter value based on a portion of the elements of message data and the elements of additional message data.

18. The computer-implemented method of claim 13, further comprising:
performing operations, using the at least one processor, that decline to execute the first real-time payment in accordance with the first parameter value based on the determination that the first parameter value is inconsistent with the execution criteria; and
performing operations, using the at least one processor, that execute the first real-time payment in accordance with the product data.

19. The computer-implemented method of claim 13, further comprising:
obtaining, using the at least one processor, mapping data associated with the message fields of the message from a data repository;
performing operations, using the at least one processor, that obtain the elements of message data from the message fields based on the mapping data; and
storing the elements of message data within the data repository using the at least one processor, the elements of message data comprising a first identifier of the first counterparty, a second identifier of the second counterparty, and the first parameter value.

20. A tangible, non-transitory computer-readable medium storing instructions that, when executed by at least one processor, cause the at least one processor to perform a method, comprising:
receiving a message associated with a first real-time payment requested from a first counterparty by a second counterparty, the message comprising elements of message data disposed within corresponding message fields, and the message data characterizing an exchange of data initiated between the first and second counterparties;
determining a value of a first parameter of the initiated data exchange based on the elements of message data, and determining that the first parameter value is inconsistent with an execution criterion; and
based on the determined inconsistency, generating product data characterizing a product available to the first counterparty, and transmitting notification data to a first device operable by the first counterparty, the notification data comprising digital content associated with the available product and with the data exchange, and the first device being configured to present at least a portion of the digital content within a digital interface.
